SEQUENCE LISTING (72 sequences)

SEQ ID NO: 1 - DNA, 20 bp, Artificial
  Synthetic
tggttcggttctcacagttc

SEQ ID NO: 2 - DNA, 20 bp, Artificial
  Synthetic
cagttaggcagcagaggaag

SEQ ID NO: 3 - DNA, 20 bp, Artificial
  Synthetic
ctaacccgagtgaggaatgc

SEQ ID NO: 4 - DNA, 18 bp, Artificial
  Synthetic
tccatccacagccaccag

SEQ ID NO: 5 - DNA, 18 bp, Artificial
  Synthetic
ggacttgagcagcccttc

SEQ ID NO: 6 - DNA, 21 bp, Artificial
  Synthetic
agagatgtcaggaccactaac

SEQ ID NO: 7 - DNA, 22 bp, Artificial
  Synthetic
agaagatgctgacaagtttgac

SEQ ID NO: 8 - DNA, 19 bp, Artificial
  Synthetic
tggatgagaggaccgagag

SEQ ID NO: 9 - DNA, 21 bp, Artificial
  Synthetic
gaggaatcagaaacgagaagg

SEQ ID NO: 10 - DNA, 19 bp, Artificial
  Synthetic
aagagtatgcgacggagag

SEQ ID NO: 11 - DNA, 21 bp, Artificial
  Synthetic
cggcaacaaggaaccaatcag

SEQ ID NO: 12 - DNA, 20 bp, Artificial
  Synthetic
cagcggcggatacctagaac

SEQ ID NO: 13 - DNA, 18 bp, Artificial
  Synthetic
gtcgttctggcgtcgttg

SEQ ID NO: 14 - DNA, 21 bp, Artificial
  Synthetic
cctcctgcttctgcttcatac

SEQ ID NO: 15 - DNA, 20 bp, Artificial
  Synthetic
cacaacaacaacaacaactg

SEQ ID NO: 16 - DNA, 20 bp, Artificial
  Synthetic
ttccattctcattgccattg

SEQ ID NO: 17 - DNA, 18 bp, Artificial
  Synthetic
ggtggctggcaacattcc

SEQ ID NO: 18 - DNA, 20 bp, Artificial
  Synthetic
aggagatggagaaggctgag

SEQ ID NO: 19 - DNA, 19 bp, Artificial
  Synthetic
ggatgtcctggcacctacc

SEQ ID NO: 20 - DNA, 22 bp, Artificial
  Synthetic
actccaatgctcctctgtctac

SEQ ID NO: 21 - DNA, 19 bp, Artificial
  Synthetic
ttgagccttgtcttccttc

SEQ ID NO: 22 - DNA, 18 bp, Artificial
  Synthetic
gttgggtggtcacttctg

SEQ ID NO: 23 - DNA, 22 bp, Artificial
  Synthetic
ctgtgttggatgattggactac

SEQ ID NO: 24 - DNA, 19 bp, Artificial
  Synthetic
ttgtgaggtggctgtatgc

SEQ ID NO: 25 - DNA, 18 bp, Artificial
  Synthetic
gtgctgggtctggttgtg

SEQ ID NO: 26 - DNA, 22 bp, Artificial
  Synthetic
ggcttcttctcttcatcatacg

SEQ ID NO: 27 - DNA, 21 bp, Artificial
  Synthetic
agacgatggtgttcctgagac

SEQ ID NO: 28 - DNA, 22 bp, Artificial
  Synthetic
tggctcaagctagtcaaggtag

SEQ ID NO: 29 - DNA, 21 bp, Artificial
  Synthetic
agaggctgttcagaagttcac

SEQ ID NO: 30 - DNA, 18 bp, Artificial
  Synthetic
gcaggtcggaagtggttg

SEQ ID NO: 31 - DNA, 20 bp, Artificial
  Synthetic
tgctgtcgctgtctctgttg

SEQ ID NO: 32 - DNA, 21 bp, Artificial
  Synthetic
tatgccacttgctttgctcag

SEQ ID NO: 33 - DNA, 18 bp, Artificial
  Synthetic
aaggctgctggctgctac

SEQ ID NO: 34 - DNA, 18 bp, Artificial
  Synthetic
cggctggtgttgctgaac

SEQ ID NO: 35 - DNA, 21 bp, Artificial
  Synthetic
aaccgctatgaagttcctctc

SEQ ID NO: 36 - DNA, 21 bp, Artificial
  Synthetic
tcctctgtgaagtctcctctc

SEQ ID NO: 37 - DNA, 20 bp, Artificial
  Synthetic
acgagcagccttctgtgtag

SEQ ID NO: 38 - DNA, 21 bp, Artificial
  Synthetic
cagcagcaatcaagtgaggag

SEQ ID NO: 39 - DNA, 20 bp, Artificial
  Synthetic
gctctaccacgccttctcag

SEQ ID NO: 40 - DNA, 21 bp, Artificial
  Synthetic
agttgctcttggtgctgtctc

SEQ ID NO: 41 - DNA, 19 bp, Artificial
  Synthetic
gacagactgcggagacaac

SEQ ID NO: 42 - DNA, 18 bp, Artificial
  Synthetic
gtccacggtgccatcttc

SEQ ID NO: 43 - DNA, 18 bp, Artificial
  Synthetic
cctcctccgccgccttag

SEQ ID NO: 44 - DNA, 22 bp, Artificial
  Synthetic
cagagacaaccagacgcagtag

SEQ ID NO: 45 - DNA, 20 bp, Artificial
  Synthetic
acatcattctcaaggtcaac

SEQ ID NO: 46 - DNA, 18 bp, Artificial
  Synthetic
tctgctacggaacttctg

SEQ ID NO: 47 - DNA, 19 bp, Artificial
  Synthetic
aacagcctgagcagcaatg

SEQ ID NO: 48 - DNA, 21 bp, Artificial
  Synthetic
agaagtagcgaacaccaacag

SEQ ID NO: 49 - DNA, 20 bp, Artificial
  Synthetic
gtctctccctgtctccatac

SEQ ID NO: 50 - DNA, 19 bp, Artificial
  Synthetic
ccaactcaccaagcacaag

SEQ ID NO: 51 - DNA, 21 bp, Artificial
  Synthetic
aagatgctgaagaaggctacc

SEQ ID NO: 52 - DNA, 21 bp, Artificial
  Synthetic
ggtgttggtgacattgaagtg

SEQ ID NO: 53 - DNA, 18 bp, Artificial
  Synthetic
cagccacggttctcagag

SEQ ID NO: 54 - DNA, 19 bp, Artificial
  Synthetic
cacacgccatcacatcaag

SEQ ID NO: 55 - DNA, 21 bp, Artificial
  Synthetic
tggagatgtggaatacctgac

SEQ ID NO: 56 - DNA, 18 bp, Artificial
  Synthetic
tggcggtgacagaatagc

SEQ ID NO: 57 - DNA, 18 bp, Artificial
  Synthetic
agcagccacaaccacaac

SEQ ID NO: 58 - DNA, 20 bp, Artificial
  Synthetic
ggagactggaagcctaatgg

SEQ ID NO: 59 - DNA, 22 bp, Artificial
  Synthetic
ggagcagaggaagaagacaatg

SEQ ID NO: 60 - DNA, 20 bp, Artificial
  Synthetic
cacacgagattgaccgctac

SEQ ID NO: 61 - DNA, 18 bp, Artificial
  Synthetic
tacacgcacgccctactc

SEQ ID NO: 62 - DNA, 19 bp, Artificial
  Synthetic
ctcacttgaccgcctttcc

SEQ ID NO: 63 - DNA, 632 bp, Mus musculus
  misc_feature (16)..(64): n is a, c, g, or t
gaattcggcacgaggnnnnnnnnnnnnnnnnnnnnnnnnnnnnnnnnnnnnnnnnnnnnnnnnntcggaatggaccccaactgctcctgctccaccggcggctcctgcacttgcaccagctcctgcgcctgcaagaactgcaagtgcacctcctgcaagaagagtgagttgggacaccttgggtggcggctaaggctaggggcggggaactcctacaaaactggctctgagaaatgtcctttgcttcccggaggccattgtattgtctcggggacagaactatacagagaactatttaaaaaaaccgaggtcttctctgttggggacaggaagcagaggtcttcagccaggctgacctcttcctcctcctttctaggctgctgctcctgctgtcccgtgggctgctccaaatgtgcccagggctgtgtctgcaaaggcgccgcggacaagtgcacgtgctgtgcctgatgtgacgaacagcgctgccaccacgtgtaaatagtatcggaccaacccagcgtcttcctatacagttccaccctgtttactaaacccccgttttctaccgagtacgtgaataataaaagcctgtttgagtctaaaaaaaaaaaaaaaaaaaaagtacagcggcc

SEQ ID NO: 64 - DNA, 566 bp, Mus Musculus
gaattcggcacgaggccatccctgagatctggacctggcttcggaattctctgcggcccagcccctcgttacccatttcctgctgaccatggatactggctctgggaatttgtgaatgccaccttcatccgagaagtactcatgcgcctggtactcacagtgcggtccaaccttatccccagccctccgacctacaactcagcgcatgactacatcagctgggagtccttctccaatgtgagctactatactcgcattctgccctctgtacccaaagactgccccacacccatggggaccaaagggaagaaacagttaccagatgttcagcttctggcccaacagctgctgctgagaagggagttcattcctgccccccagggcaccaacatcctgtttgccttctttgcacaacacttcacccaccagttcttcaagacctctggaaagatgggtcctggctttaccaaggccttaggccacggggtagaccttggccacatttatggagataatctggaacgacagtatcacctgcggctcttcaaggatgggaaacttaagta

SEQ ID NO: 65 - DNA, 462 bp, Mus Musculus
gttatgaaaggatacacagccaagcacaattcctgcaaccccattgacaaccaacagtggcctgatgcctccctctgtcgcagttgttggacctttacacatacctcagaacataaaattttcttcagctcctgtaacacctaatgtcccctccagtagtcctgctccaaatatacagacaggtcggccattggtccttagctcacgagccactcctgttcagctgccttcccctccttgtacatcctctccagttgtcgctcctaatccttctgtccagcaagtaaaagaattaaatccagatgaggctagtcctcagacgaacacctcagcagaccagagcactctgcctccttcacagccaaccacagtagtttctccccttttgaccaatagtccaggctcctctgccaatcgtcgaagcccagtctcatccagtaagggcaaaggaaaagtggacca

SEQ ID NO: 66 - DNA, 676 bp, Mus Musculus
gaattcggcacgaggtgggagcctgattctaccaagtcggaaattgaaggacggccagaaaccatctttcaactgtgctgcagtgacagcgagaacaaaaccagcattgttaaggtgattcgttctattctgagagagaacttccggcgccacataaagtgtgagctgccactggagaagacgtgtaaggaccggctagtacctcttaagaaccgagttcctgtttcagccaaattagcctcgtccaggtcgttgaagggcctcagaacatcctccagcagcgagtggcccagcgagcccagcaagggcaactcactggactcagatgagtgcagcctgagcagtggcacccagagtagcggctgccccgtagccgagagcaggcgagactctaagagcaccgagctggagaaagacgctcaggagggcctggcggagtttccagatggtcttatcaaagaaagcgacattctgagtgatgaagatgaggacttccaccaccctctgaaacagggtagccctactaaggacattgagattcagttccagagactgacaatctctgaggaatccgacgtgcacccagttgggcagcagcctctcacagagtcaggtgaacagcccaagctggtcaggggccatttttgccccattaaacggaaagcaaacagcacca

SEQ ID NO: 67 - DNA, 351 bp, Mus Musculus
tagaccagttccattgagtgtgtatggcagctaacggaacagttccttgcgcctttgagttcaacgagaggtttctgactcacattcagcatcatgtttattcctgccagtttgggaacttcctgtgtaatagccagaaggagaggcgagaactcaagattcaagaaagaacctactctttgtggtccaacctgtggaagaatcgagctgactacctcaatcctctgtttagagctgaccacagtcagacccaggggagccttcatctgcctacagctccatgcaacttcacctataagttttggaatgggatgtataaccgctttgaaaaggggttgcagcctcgacagt

SEQ ID NO: 68 - DNA, 526 bp, Mus Musculus
tcggctgtccctgtgctgttaacaatgcccgggaagcaaccctgaggtgcggagcaatgccatctttgggttgggcgtactggcagagcatggcggctgccctgctcaggaccacttccctaagctactgggcctccttttgcccctgctggcaagggagcgacatgatcgagtccgtgataacatctgcggggctcttgcccgtgtactgatggccagtccagtaggaaaaacggagccccaggtgctggctaccctgctacgtgcccctgcccctgaaggaagacatggaggagtggctcactataggtcacctcttcagcttcctgcaccagaacaatcctgagcaggttgtggatgtggcttcagaactcctgcgcatctgcagcctgatcctgccggacaaccggatccctccagacaccaaggcggccctgctgctgctcctgacgttcctggccaagcagcacaccgactgcttccacacagccctgggctctctgccaaatgataaagctcaggaact

SEQ ID NO: 69 - DNA, 243 bp, Mus Musculus
agccttagtgaatgtacagtacctagacttctgtgttcgcgcagaagggagcaactttgctatttggtccagtaagtggacaacttgtgatataaatgtggaaataacaaaaatatttgcacaaaccagttttggaatcatttctcatttgcacatgtatagctaaatctggcctttcctacaggggtaagtgcctggagcccacatccatacctacttatgccagccttggtgacatccctt

SEQ ID NO: 70 - DNA, 550 bp, Mus Musculus
tgccgggatgagaagtgtgtgtatgagacatgggtgtgtgatgggcagccatactgtactgacggcagtgatgagtgggactgctcctacgccctgccccgaaaagtcatcacagcagcagtcattggcagcctggtgtgtggcctgttgctggtcttcgctctcggctgcacctgcaaactctatgccatccgcacccaggaatacagcatctttgccccgctctcccggatggaggctgagattgtgcagcaacaggcacccccttcctatgggcagctcattgcccagtgtgccatcccgcctgtggaagacttccccacagagaaccctaacgataactctgtgctgggaaacctacgttctctgcttcagatcttacgccaggatatgactccaggtggtacttcagggggccgccgtcgccagcgtggacgctccatccgccgtctggttcgccgtctccgtcgttggggcctgcttcctcgaactaataccccagctcgggcccctgagaccagatcccaggtcacaccctctgttccctctg

SEQ ID NO: 71 - DNA, 361 bp, Mus Musculus
  misc_feature (205)..(205): n is a, c, g, or t
taacttcaagtggaaaatctgaatacattgaacctgccaaacgagctcatgttgtgccgccacctagaggccggggccggggaggatttggacagggcatacggccccatgatattttccgtcagagaaagcagaacacgagcaggccgccatctatgcacgtggatgactttgttgcagctgaaagtaaagaagtggtccctcnagatggaatacccccaccaaaacgggcactcaaagtctcacnaaagatttcctctcgtggtggattttcaggcaaccgaggaggacggggtgcttttcatagtccgaacaggtttttcacaccgcctgcttcgaaaggaaactacagtcgtcggga

SEQ ID NO: 72 - DNA, 604 bp, Mus Musculus
tcggcacgaggcttactgtaaaaagaaactagaggatttttggaaaaaaaataatctattttagagtttatttgctgacctgctttttacacactttcatgtgaaagagacagagaggggcaaggttggcgctgcttgttttgaagctggtgcctcccttgcatggccgcacgctgggagcctgtggcctcccagactgagcctgcaacaagtgtggggctgttccacatgccgccccgtcacggcggtgaggccattccacatcgtttttaaactaatgttttctatattaacattattctggctatctggctttcacgggccacgcacaggtgtgcgagtgggacatcccatgctccaatcaaagggatttttagcagtgcctctgatcaagcactgccaagtcagctccacatccgtttccccccttccccttttttgtcagtattatttgggaaggagacatgccaggacaatgtcattgtgctacatgcagaaaatcatgtttcctgttggcacaaagttgcacaggagtaaacatgagcatgtttaacaggtttgtcttttcttcacctatcttatttatttaacctgccattgtgtg

(19) United States
(12) Patent Application Publication
(10) Pub. No.: US 2012/0165223 A1
(43) Pub. Date: Jun. 28, 2012

(54) Human Intestinal Normal Bacterial Flora DNA Chip and Method for Estimating Harmness to Human Body Due to Change of Human Intestinal Normal Bacterial Flora Using DNA Chip

(76) Inventors: Sang-Hee Jeong, Gyeonggi-do (KR); Soo-Jeong Park, Gyeonggi-do (KR); Hyun-Ok Ku, Gyeonggi-do (KR); Hwan-Goo Kang, Gyeonggi-do (KR); Joon-Hyoung Cho, Gyeonggi-do (KR)

(21) Appl. No.: 13/414,430

(22) Filed: Mar. 7, 2012

Related U.S. Application Data
(62) Division of application No. 13/176,081, filed on Jul. 5, 2011.
Application No. 13/176,081 is a continuation of application No. 11/700,471, filed on Jan. 31, 2007, now abandoned.

(30) Foreign Application Priority Data
Feb. 1, 2006 (KR) 1020060009731

(51) Int. Cl. C40B 30/04

(52) U.S. Cl. 506/9

(57) ABSTRACT

The present invention relates to a DNA chip showing specific responses to a human intestinal normal bacterial flora and a method for estimating harmness to the human bodies due to the change of the human intestinal normal bacterial flora using the DNA chip.

This application is a divisional of U.S. Ser. No. 13/176,081, filed Jul. 5, 2011, which is a continuation of U.S. Ser. No. 11/700,471, filed Jan. 31, 2007, which claims the benefit of foreign priority to application 10-2006-0009731 filed in the Republic of Korea on Feb. 1, 2006. These applications are herein incorporated by reference in their entirety.

### BACKGROUND OF THE INVENTION

1. Field of the Invention

The present invention relates to a DNA chip showing specific responses to a human intestinal normal bacterial flora and a method for estimating the harmness to human bodies due to the change of the human intestinal normal bacterial flora using the DNA chip, more particularly, to a method for manufacturing a DNA chip showing specific responses to the human intestinal normal bacterial flora by confirming and selecting 90 genes which respond significantly to the change of the human intestinal normal bacterial flora in colonic crypt cells of the mice expressing a human intestinal normal bacterial flora and by amplifying and purifying the same, and for estimating the harmness to the human bodies due to the change of the human intestinal normal bacterial flora using the manufactured DNA chip.

2. Description of the Related Art

Human beings get materials to be an energy source or the components of the body from the outside. The specially developed organ to digest and absorb these materials in the shape capable of being used by the body is a digestion system, which is an organ consisting of the stomach and the intestine and is mainly in charge of digestion. The digestion tube is a tube from the mouth to the anus, and has the entire length of 10 m and the surface area amounts to about one tennis court. The intestinal germs are settled on and fill the wall surfaces of the digestion tube which carries out digestion and adsorption.

The intestinal germs make a living on the foods eaten by the human, a fluid secreted from the intestinal tube and a mucus covered the intestinal wall as a nutrition source and produce a great amount of organic compounds. The germs in the general environment can enter a gastrointestine of the human beings via food but die due to a gastric add, bile and the like. The germs are released to the exterior of the body in about one week even if they survive and no germs are settled. In the meantime, the intestinal normal bacteria is mainly an anaerobic bacteria susceptible to the natural environment but survive under a gastric add or bile in the gastrointestine of the human body and is well adapted to the environment of the gastrointestine to flourish. That is, the intestinal germs are peculiar ones having features different form those in the natural environment.

The intestinal germs are composed of different kinds and amounts by portions of the gastrointestine and are distributed and settled. The group of intestinal germs formed in this way is referred to as an intestinal normal bacterial flora. The strains comprising an intestinal normal bacterial flora are not well settled in upper portion of the gastrointestine because of a strong gastric acid, but are well settled in ileum, caecum and colon. The intestinal bacteria with a great amount and kinds settled in a digestive system perform influential operations corresponding to internal organs of host. Especially, the colon occupying the largest area in a large intestine has 10¹¹⁻¹² intestinal germs per 1 g of the content and occupies 60% of the solid. The colon tissue contacting the intestinal normal bacterial flora is mucosa layer comprising epithelia comprising crypt cells, larmina propria and muscularis mucosa. The crypt cells respond very sensitively to the external stimulus such as the change of the intestinal normal bacterial flora and have a flourishingly augmenting ability of cells to perform an important role in maintaining the homeostasis of the colon epithelial cells.

The existence of the intestinal germs affects the shape of internal organs. In case of germ-free animals without intestinal bacteria, the villus of the intestines are not developed and they have weak but enlarged caecum several times as compared with general animals (Refer to FIG. 1A).

The intestinal bacteria have effects on human beings as follows. The intestinal bacteria decompose protein or carbohydrate and disassemble the fibroid materials which are not absorbed to help digestion. In addition, the intestinal germs have effects on the metabolization of cholesterol or a neutral fat (trigliceride) and carbohydrate by which the blood sugar is maintained to proper value. The acid such as a lactic acid or an acetic acid, etc. produced by the intestinal bacteria makes pH in the intestines into acid, resulting in promoting a peristalsis of the intestines and improving the digestion. In addition, the exterior germs which do not die by gastric acid or bile and the like can not be settled because the intestinal germs cover the intestinal mucous membrane, in other words, defend it from infections. Some intestinal germs decompose the cancer causing materials like nitrosoamine or trip-P-I, and make the above non-carcinogenic, and degrade the amount of lipid peroxide having the possibility to cause a cancer. Furthermore, some intestinal germs produce steroid hormones, vitamin B1, vitamin K, biotin, folic acid and the like to have an effect on a weight control of human beings. Moreover, the intestinal germs stimulate an immune system.

In general, the intestinal germs are settled with tightly controlled balance to maintain homeostasis even if various factors disrupting the balance such as an imbalanced diet, medication of antibiotics, an aging and a pressure are applied. The intestinal germs have effects on human beings in obtaining nutrition and preventing infections by these operations and are helpful in maintaining the health. However, if some factors to disrupt the balance are continuously applied for a long term, the ability to return the intestinal bacterial flora into a normal state disappear and the intestinal bacterial flora show abnormalities.

If the balance of the intestinal bacterial flora is broken, beneficial germs in the intestines (mainly lactobacillus) are decreased and harmful bacteria or pathogens are increased. The disruption of the intestinal normal bacterial flora causes to form abnormal intestinal bacterial flora inducing the production of harmful materials, abnormalities of digesting functions, the decrease of beneficial germs and infection due to augmentation of pathogens may cause diseases or deteriorate immunity.

As described above, the human intestinal normal bacterial flora performs important physiological functions as absorbing nutritions, defending intestinal mucous membrane, metabolizing exterior compounds, forming blood vessels, maturation of digestion functions of newborn babies, defending them from the exterior pathogens and the like. In case that human beings are exposed to antibacterial agents by various drugs or foods or a harmful compound, the barrier wall formed by intestinal normal flora colonized in the intestinal mucous membranes may be disrupted, a resistance may be caused, metabolizing abilities may be attacked or a colon cancer may be induced by the occurrence of abnormalities of the human intestinal normal bacterial flora. The estimation of hazardous effect of the antibacterial materials resided in the foods with respect to the intestinal normal bacterial flora can be performed by a test for disrupting a colonization barrier effect in a test tube, a test for using an anaerobic continuous flow culture system and a test for using a human flora-associated mouse, but they require for special testing facilities and the test methods are very complicated in identifying germs, because there are thousands of human intestinal normal bacterial flora and anaerobic germs occupy 99% or more. In addition, the change of a human intestinal normal bacterial flora can only be known from the existing test methods but the direct effects on the final host animals can not be known.

The human intestinal normal bacterial flora is nearly ten times greater in number than the number of cells of a human body and inhabits in the intestines of the human bodies with maintaining a dose symbiosis relationship with the human body, 300 to 500 kinds of germs keeping the harmony. These prevent the exterior pathogens from propagating excessively in the intestine tubes. Furthermore, these produce short chain fatty acids to provide an energy source and play important roles in producing vitamin K, absorbing ions, augmenting intestinal tubal epithelial cells and controlling differentiation to improve immune functions. In case of intaking the exterior harmful chemical materials and letting them to go through a large intestine, they have impacts on the function and balance of the normal bacterial flora in the intestines.

Especially, a trace amount of antibacterial materials remaining in the foods cause a human intestinal normal bacterial flora to be disrupted, a degradation of the defending functions of intestinal mucous membrane, an obtaining a resistance of the human normal bacterial flora.

In order to examine if the human intestinal normal bacterial flora are disrupted by an infinitesimal antibacterial materials remaining in the foods and the disrupted degree, a test for disrupting a barrier effect of normal flora in test tubes using a human intestinal normal bacterial flora, a test for using an anaerobic continuous flow culture system and a test for using mice expressing a human intestinal normal bacterial flora were conventionally used (Cemiglia, C. E. and Kotarski, S., 1999 Reg Toxicol Pharmacol 29, 238-261; Rumney, C. and Rowland, I., 1995 Fd Chem Toxic 33).

The test for disrupting a barrier effect of normal flora in test tubes using a human intestinal normal bacterial flora is a method comprising the steps of picking the feces of healthy persons; isolating representative ten kinds of strains of a human intestinal normal bacterial flora and identifying them; cultivating them in a test tube each strain by ten colonies for 100 colonies in total; injecting an antibacterial material to this liquid culture medium and obtaining the minimal inhibitory concentration (MIC) of each strain to set a geometric average of the minimal inhibitory concentration (MIC) of the most sensitive strain as the lowest observed effect concentration. However, this method is disadvantageous in that it does not reflect a complicated intestinal environment and can overestimate the effects of antibacterial materials on the human intestinal normal bacterial flora and the effect on causing a resistance can not be confirmed. (Rumney C. and Rowland I., 1995 Fd Chem Toxic 33, 331-333; Nouws, J. F. M., et al., 1994 Vet Quart 16, 152-156).

The test of anaerobic continuous flow culture system is a method comprising the steps of injecting the human feces in a anaerobic culture vessel designed to be as similar as possible to the human intestinal environment using an anaerobic bacterial flow culture system; cultivating human flora stably for 20 days and cultivating further for 15 days after injecting an antibacterial material; examining the total number of bacteria and the change of the representative strains, a resistance occurrence and the change of enzymes produced by a human intestinal normal bacterial flora but is disadvantageous in maintaining the anaerobic continuous flow culture system of the human intestinal normal bacterial flora stably for a long time. (Gibson G. R. et al., 1988 Appl Environm Mivrobiol 54, 2750-2755; Carman, R. J. and Woodbum M. A., 2001 Reg Toxicol Pharmacol 33, 276-284; Carman R. J. et al., 2004 Reg Toxicol Pharmacol 40, 319-326).

The test using mice expressing a human intestinal normal bacterial flora is a method for overcoming the disadvantages of the uppermentioned in vitro tests which does not reflect complicated intestinal environment of a living body. The human feces liquid is injected to a germ-free mouse and then the kind and number of strains of the settled intestinal normal bacterial flora inside the intestines and the activity of enzymes produced by them is investigated to confirm if the mouse is HFA. After the mouse is confirmed as HFA mouse, an antibacterial material is injected orally to the HFA mouse and the total number of bacteria in the intestines, the change of the number of representative strain, the causing of resistance, the change of enzymes produced by a human intestinal normal bacterial flora and measured. (Perrin-Guyomard A. et al., 2001 Reg Toxicol Pharmacol 34, 125-136). The in vivo test has an advantage in that a complicated human intestinal environment is sufficiently reflected but is disadvantageous in that fussy separation and identification of intestinal normal bacterial flora and tests for causing a resistance and metabolic activity test have to be carried out.

In addition, the human intestinal normal bacterial flora has thousand kinds and of which 99% is anaerobic bacteria. In order to examine if the human intestinal normal bacterial flora is disrupted by a trace amount of antibacterial materials remaining in foods and the disrupted degree, the three test models require for special test facilities and have a complicated method to identify bacterial strains and have limitations that the impaction on the human intestinal normal bacterial flora can just be known and the direct effects on the final host, the human being is not known.

### SUMMARY OF THE INVENTION

Accordingly, the present invention has been made keeping in mind the above problems occurring in the related art, and an object of the present invention is to provide with a DNA chip manufactured with confirmed and selected 90 genes which respond significantly to the change of the human intestinal normal bacterial flora in colonic crypt cells of human flora-associated mice in order to estimate the harmness to a human health due to the disturbance of the human intestinal normal bacterial flora and amplifying and purifying them.

Another object of the present invention is to provide with a method for estimating the harmness to a human body due to the change of a human intestinal normal bacterial flora using the DNA chip.

The present invention designed to attain the objects includes a DNA chip showing specific responses of colonic crypt cells by the disturbance of human intestinal normal bacterial flora comprising a part of at least one gene selected from the list of genes attached on a substrate. The above gene list (A) includes: Dap3(Bm:ABU_C09), Rpa1(Bm:ABP_H12), Ccnd2(Bm:AEP_K17), Cdc45I(Na:NIA3003_E07), Gmnn(Bm:AGF_M21), Cul4b(Bm:AEC_F06), Tacc2(Na:NIA3069_A06), Bnip3I(Bm:AAL_E04), Slc26a1(Bm:AFI_I21), Ddx1(Bm:AFN_L15), Cacnb3(Bm:AAI_H09), Rpl27(Bm:AEF_E03), Slc22a1I(Bm:AAJ_D02), Cav(Bm:AFG_N24), Tuba4(Bm:AEY_P08), Lrp10(Bm:AAR_E09), Mt-1(Bm:AEM_N04), Tiam2(Bm:ADK_C04), Zdhhc3(Bm:AEP_E23), Rhcg(Bm:AES_K17), Ipo4(Bm:AGY_I13), 2610529I12Rik(Na:NIA3077_F05), Igj(Bm:AGH_C22), Daf1(Bm:AES_D14), II18(Bm:AAE_D12), Tnfsf13b(Na:NIA3053_A01), Prkrir(Bm:AGR_I18), Serping1(Bm:ABN_C10), Eif2ak3(Bm:AEO_B20), Mpp1(Bm:AEN_O20), Lnx1(Bm:ACT_E12), 4732481h14Rik(Bm:AFF_J18), Rgs12(Na:NIA3059_B02), Dcamkl1(Bm:AAI_C05), Mllt1(Bm:AEP_D08), Per1(Bm:AAB_C08), Keap1(Bm:AAC_C04), Hdac5(Bm:ADT_B10), Ncoa6(Bm:ADF_C03), Crem(Bm:ABV_C11), Crsp7(Bm:AER_B19), Rnf12(Bm:AGF_K06), Alas1(Bm:AAA_G04), Cotl11(Bm:AAH_C12), Gstm2(Bm:AAQ_G09), Siat9(Bm:ABA_B11), 5430437P03Rik(Bm:ABC_A11), Purb(Bm:ABG_E06), Col3a1(Bm:ABQ_B08), II16(Bm:ACE_C02), Mut(Bm:ACJ_G08), 6330590F17Rik(Bm:ACK_D02), Srpk2(BmACM_B04), Klf3(Bm:ADH_G12), Cited1(Bm:ADI_E04), D230019K24Rik(Bm:AEH_D09), Ugcg(Bm:AEH_E04), Au043625(Bm:AEX_I02), Rw1-pending(Bm:AEX_I06), Hsd17b2(Bm:AFJ_K09), 5031404N19(Bm:AFP_D16), Tccr(Bm:AFP_I13), Npm1(Na:NIA3030_D07), Sh3glb2(Bm:AAB_F01), Aldh6a1(Bm:AAC_C10), Plp(Bm:AAF_E03), Ptgs1(Bm:AAN_F02), Fads3(Bm:AAT_G11), Parva(Bm:AAW_H11), C130039O16(Bm:ABH_B06), Epc1(Bm:ACL_F06), CPd(Bm:ACU_C09), Mtmr7(Bm:ACV_C10), 4930455F23Rik(Bm:ADM_F04), Rab6ip1(Bm:ADP_D01), Mcpt4(Bm:ADQ_A08), Fn3k(Bm:ADX_E02), 1110037F02Rik(Bm:ADZ_G06), 1110038M16Rik(Bm:AEU_G22), 1700012H17Rik(Bm:AEV_D01), Thsd1(Bm:AEW_I03), 9830148O20Rik(Bm:AFE_E24), Ptgs2(Bm:AFG_N09), Tcp11(Bm:AFJ_I02), Guca1a(Bm:AGB_L08), Usp15(Bm:AGH_H15), Ybx2(Na:NIA3045_E04), Tcl1(Na: NIA3058_G02), Cldn8(Na:NIA3064_H02), Ckap2(Na:NIA3119_C04).

In addition, the present invention includes a DNA chip showing specific responses to a human intestinal normal bacterial flora comprising at least one selected from the gene list (A).

Furthermore, the present invention indudes a method for estimating the harmness to a human body by the change of a human intestinal normal bacterial flora, comprising the steps of (1) reacting the cDNA labeling the fluorescent material from the RNA sampled and amplified from a colonic crypt cell to a specific DNA chip attached by at least one gene selected from a gene list (A) of claim 1 or 2; and (2) confirming the fluorescent degree of the degree of gene expression on the specific DNA chip via a DNA scanner.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The above and other objects, features and advantages of the present invention will be more clearly understood from the following detailed description taken in conjunction with the accompanying drawings, in which:

FIG. 1A shows the measured lengths of the intestine and the large intestine of germ-free (GF) mice, specific pathogene-free (SPF) mice, human flora-associated (HFA) mice, HFA/Tc mice (HFA mice which are orally administered by 200 mg/kg of Tetracycline for four days) and HAF/Cip mice (HFA mice which are orally administered by 200 mg/kg of Cyprofloxacin for four days) (mm % of GI length);

FIG. 1B shows the composition of bacterial flora in the feces of germ-free ICR mice injected by human feces (count/g feces);

FIG. 1C shows the change of the activities of metabolic enzymes in the human feces from day 4 to day 14 after the injection of human feces to germ-free mice and the feces of the SPF mouse and the HFA mouse;

FIG. 2 shows genes profiles from mRNA of crypt cells of HFA/GF, HFA-TC/HFA and HFA-Cip/HFA responding specifically to the DNA chip of mice in use;

FIG. 3A shows the results of analyzing the expression of Tegt, Casp14, Spn2a, I16 and Eif2ak3 genes using DNA chips;

FIG. 3B shows the results of analyzing the expression of Tegt, Casp14, Spn2a, I16 and Eif2ak3 genes using RT-PCR;

FIG. 4A shows the results of analyzing the expression of Mpp1, Slc26a1, Saa3, Mt1 and Ang genes using DNA chips;

FIG. 4B is a view showing the results of analyzing the expression of Mpp1, Slc26a1, Saa3, Mt1 and Ang gene using RT-PCR;

FIG. 5 is a picture of a DNA chip showing specific responses to a human intestinal normal bacterial flora;

FIG. 6 is a picture showing the dye opinions of syto61 after the DNA chip is completed;

FIG. 7 is a picture showing the change of the composition of the human intestinal normal bacterial flora during the period for administering a drinking water containing 500 μg/Ml of colistin to HFA mice; and

FIG. 8 is a picture showing the change of the metabolic functions of a human intestinal normal bacterial flora during the period for administering a drinking water containing 500 μg/Ml of colistin to HFA mice and the period for five days after the administration is stopped.

### DETAILED DESCRIPTION OF THE INVENTION

Hereinafter, the present invention now will be described in more detail.

The epithelial cells of digesting organs contact an intestinal normal bacterial flora and covered with protection layers which are colonies formed by the intestinal normal bacterial flora. The intestinal epithelial cells are originated from crypt cells located on the base of themselves. Accordingly, the overgrowth of crypt cells and the abnormalities of differentiation may refer to the disturbances of intestinal micro flora for the crypt cells may react very sensitively to the exterior stimulus. (Varedi. M et al., 2001 Am J Physiol Gastrointest Liver Physiol 280, G157-G163).

Therefore, in order to examine the change of functions of a large intestine in accordance with a human intestinal normal bacterial flora in the present invention promptly, simply and sensitively, genes originated from the crypt cells of the colon intestinal epithelium of which the expression is controlled by the a human intestinal normal bacterial flora are selected and amplified to manufacture a gene chip using a microarray technology.

According to the present invention, it is preferable that ICR mice at six to seven weeks old are grown free from germs in an isolator and Bacteroides fragilis (ATCC 25285, 10⁷ CFU/ml) be orally administered in the dose of 0.2 ml per one to the gastropylorus and after two days the human feces 1% liquid (in pre-reduced TGY broth) be injected to the gastropylorus by 0.2 ml per one. Next, the length of a large intestine, the distribution of bacterial flora of the feces and the change of the metabolic enzyme activities are measured. It is confirmed 12 days after the injection of the human feces to the HFA mice can be used in the present tests. The HFA mice are administered orally by tetracycline or ciprofloxacin which are antibiotics may cause the intestinal normal bacterial flora to be disrupted.

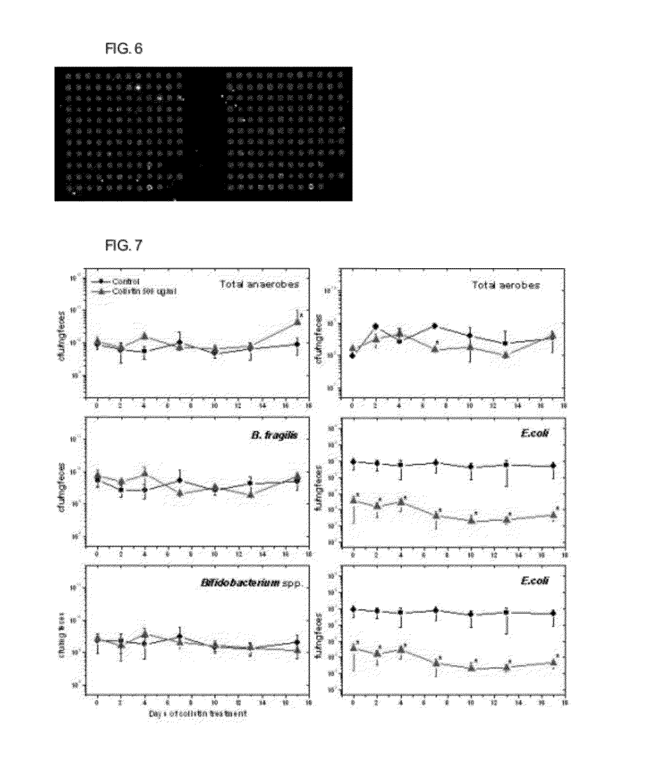

In the preferred embodiment of the present invention, tetracydine and ciprofloxacin are orally administered to the HFA mice by 200 mg/kg for four days, their abdominal cavities are opened asceptically to pick a colon and the intestinal contents are cleaned with a sterilized saline solution and put on a cryomold having an OCT compound and then covered with the OCT compound again to maintain it in a freezer at the temperature of −80° C. Next, the frozen tissues are cut with the thickness of 8 μm and put on a glass slide and stained with hematoxyline to observe crypt cells of the colon of mice using a laser captured microdissector and to separate RNA from cells and purify them. The purified RNA is amplified using dt-oligomer as a primer and of which the purity is confirmed. And then the amplified cDNA is reacted with a mouse DNA chip commercially used so that the specifically reacted genes can be selected. In addition, the reactivity of the selected genes is reconfirmed using a qRT-PCR method and finally 90 specific genes, 26 house-keeping genes and selected four control genes (Refer to table 1 and FIG. 5). The genes are distributed from the Korean Biotechnological Institute as dones and the done Id (BMAP/NIA name) including the genes corresponding to each gene name is indicated.

The genes showing specific responses to human intestinal normal bacterial flora can be classified into genes relating to apoptosis, cell cycling, cell death, cell growth & maintenance, immune response, response to stress, signal transduction and transcription and other genes.

The 90 specific genes include the genes related to apoptosis and cell death responses such as Dap3 and Bnip31, the nine genes related to a cell cycling including Rpa1, the 20 genes related to growth and maintenance of cells including S1c26a1, the seven genes related to immune response including Igj, the five genes related to the response to stress including Prkrir, the 15 genes related to signal transmission including Mpp1, the 14 genes related to transcription including M11t1 and other 18 genes of which the functions are identified so far including Rw1-pending and the like.

In addition, according to the present invention, it is possible to manufacture a gene chip showing specific responses to a human intestinal bacterial flora, consisting of 120 genes selected using a Microarrayer (Cartesian or equivalent) on a glass slide. The gene chip may have an array shown in FIG. 5, which is just one embodiment configuring the present invention and the array type can be easily selected by those skilled in the art. It is preferable that each gene selected on a glass being a substrate be separated with a predetermine distance, genes with the concentration of 100 to 200 ng/μl per point being arrayed 1 μl. The process for manufacturing the gene chip and the test process using the chip will be described more in detail in the embodiments of the present invention.

In order to confirm that the human intestinal normal bacterial flora of the above genes is disturbed, the number of required genes cannot be specially limited and the expressing types may differ depending on the points of picking the cells. However, the 90 genes raised on the gene chip are selected from mice expressing a human intestinal normal bacterial flora in contrast to germ-free genes, mice expressing a human intestinal normal bacterial flora exposed to the representative wide-spectrum antibiotic tetracydine in contrast to a human intestinal normal bacterial flora, and genes specially reacting in accordance with the change of a human intestinal normal bacterial flora in the mice expressing a human intestinal normal bacterial flora exposed to the ciprofloxacin which operates to colon bacillus and gram negative bacteria (genes showing the difference in the expression degrees by more than two times) and it is possible to find out that the human intestinal normal bacterial flora is chan_{g}ed even if a part of data is detected. Preferably, if about more than 20 genes show the change in the increase and the decrease which can be referred as the change occurring when the human intestinal bacteria are disrupted, it is enough to find out the effects of antibiotics on the human intestinal normal bacterial flora. Furthermore, the genes showing the difference in the expression degrees by more than twice were selected by leading to an extreme situation in the change of the intestinal normal bacterial flora but it is preferable that the difference in the increase and the decrease by 1.5 times be a similar change in the real condition. Furthermore, even if a small number of genes with about 100 kinds are raised on a gene chip, it is a test performed by publicly announcing the medical treatment to a living body and the entire genes and the control genes are all originated from the same individual. Therefore, it is recommended to normalize all the genes into expressing values and then measure them when analyzing the difference of the expression degrees.

For example, after orally administering or exposing unknown chemical materials or materials remaining in the foods to HFA mice, it is possible to separate genes from crypt cells of colonic epithelial cells and react them with gene chips showing specific responses to the human intestinal normal bacterial flora and then search for the gene expression. The genes which well express with 26 house-keeping genes and control genes but are observed to decrease the expression when the mice are in germ-free status or the human intestinal normal bacterial flora is disturbed due to the treatment by antibiotics like tetracycline or ciprofloxacin are as follows: Slc26a1, Ddx1, Cacnb3, Cav, Igj, Daf1, Mpp1, Lnx1, Cotl1, Serping1, Siat9, Au043625, Tccr 4732481h14Rik, Alas1, Keap1, Gstm2, Purb, MutSrpk2, Klf3, Cited1, Ugcg, Hsd17b2, Npm, D230019K24Rik, Gmnn, Cul4b, Tacc3, Lrp10, Zdhhc3, 2610529I12Rik, Crem, Crsp7, Epc1, Thsd1, Tuba4, Mt-1, Dcamk11, Ncoa6, Rnf12, Sh3glb2, Aldh6a1, Ptgs1, Cpd, 1700012H17Rik, Ptgs2, Tdl1, Tiam2, Ipo4, Tnfsf13b, Tcp11.

If the genes showed that the expression is changed by about 1.5 times, it is doubted that the human intestinal normal bacterial flora is changed or controlled to degrade the intestinal functions or defending abilities.

It is possible to estimate the harmness of trace levels of antibacterial material remaining in the foods to the human body using a gene chip showing specific responses to the human intestinal normal bacterial flora according to the present invention promptly and sensitively. Furthermore, it can be used in examining the failures of the functions of a large intestine occurring from the abnormalities of the human intestinal normal bacterial flora due to drugs or exterior pathogenic bacteria simply and sensitively.

According to the present invention, the genes which sensitively react to the change of a human intestinal normal bacterial flora can be selected and make a gene chip on a slide by arranging themselves. Therefore, it is possible to estimate the direct harmness to the human body due to the disturbance of a human intestinal normal bacterial flora impacted by the chemical material, which is originated from the exterior, intaken in a real living body system.

### DESCRIPTION OF THE PREFERRED EMBODIMENTS

A better understanding of the present invention may be obtained in light of the following examples which are set forth to illustrate, but are not to be construed to limit the present invention.

### Embodiment 1

### Creating Mice Expressing a Human Intestinal Normal Bacterial Flora (HFA mice) and Confirmation Thereof

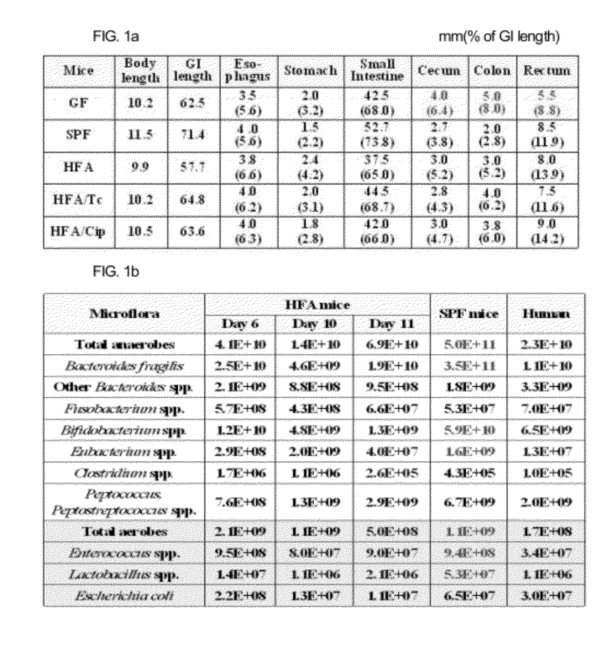

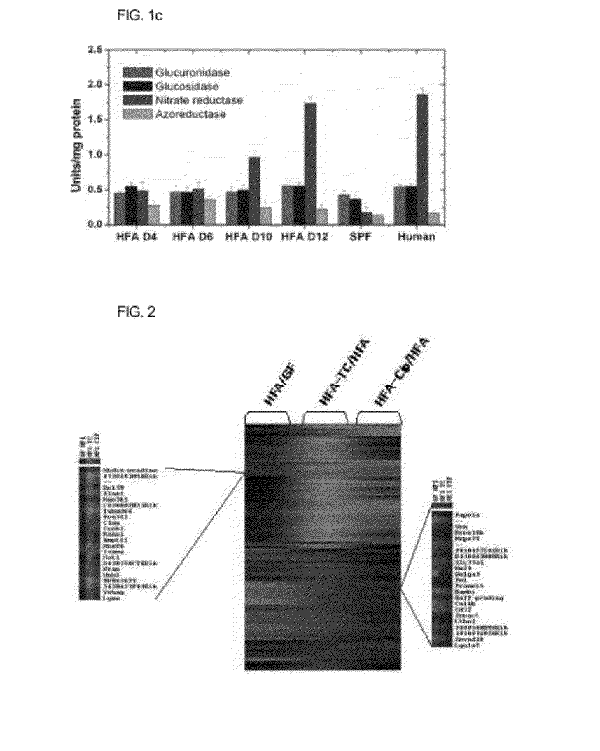

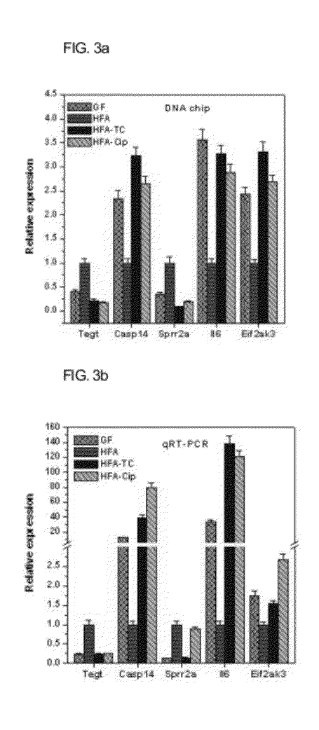

The germ-free ICR mice (female, male, CLEA, Japan) at six to seven weeks old are introduced and put in a germ-free isolator (filtering air of 0.2 μm) to be confirmed that they are completely freed from germs via a bacterial test of feces in the anaerobic and aerobic incubation conditions. It is confirmed that the mice are free from germs through the continuous test of feces when they are adapted in the isolator for one week. One week after they were adapted, Bacteroides fragilis (ATCC 25285, 10⁷ CFU/ml) is orally administered in the dose of 0.2 ml per one to the gastropylorus and after two days 0.2 ml per one of the 1% diluted liquid feces obtained from healthy human beings (in pre-reduced TGY broth) is injected to the gastropylorus. Next, the length of a large intestine, the composition of bacterial flora of the feces and the change of the activities of metabolizing enzymes are measured and it was confirmed that the human intestinal normal bacterial flora is stably settled. (FIG. 1c) The HFA mice showing the same composition of bacteria as the human normal bacterial flora and metabolic enzyme values are maintained stably in the present test conditions.

### Embodiment 2

### Selecting Genes Showing Specific Responses to the Human Intestinal Normal Bacterial Flora

1) Creating Colonic Crypt Cells

Tetracycline, the representative wide spectrum antibiotic and Ciprofloxacin, a fluoroquinolone antibacterial affecting colon bacteria and gram negative bacillus are orally administered to HFA mice for four days by 200 mg/kg and they are autopsied in 24 hours since the last administration to collect colon samples. The collected colon is opened and intestinal content is cleaned with a sterilized saline solution and put in a cryomold in the longitudinal direction to be embedded as an OCT compound and then it is maintained in a freezer at −80° C. The frozen tissue is cut to have the thickness of 8 μm using a cryotome, put on a glass slide (HistoGene LCM slide, Arcturus) and cleaned using a staing (HistoGene LCM frozen section staing kit, Arcturus) and then a hematoxylin stain is performed and then dehydrated. The stained colonic tissue slide of the dyed mice is put on a laser captured microdissector (PixCell II, Arcturus) and crypt cells are isolated from the colon by a laser.

2) Separating RNA and Amplifying mRNA

Total RNA is separated and purified from crypt cells using a RNA purifying kit (Picopure RNA isolation kit Arcturus). mRNA is amplified using the RNA amplifying kit (RiboAmp, Arcturus) with respect to the purified total RNA. In order to confirm the purity of the finally amplified and purified poly(a)RNA, it was confirmed that it has an optical density of 260 nm/280 nm ratio of 1.9 to 2.8 and is runned on an agarose gel without forming special bands such as 28S and 18S and further rRNA was not contaminated.

3) cDNA Labeled With Cy3- or Cy5- Are Loaded and Selecting Genes Showing Specific Responses

The amplified aRNA (24 μl) of 10 μg is mixed with random hexamer (5 mg/Ml) of 2 μl to be 24 μl which is heated for 10 minutes at 70° C. The first strand master mix liquid of 26 μl containing Cy3- or Cy5-dUTP (1 mM, respectively) is added to aRNA and reacted for two hours at 37° C. After Rnase H with 2 units is put into each reactive tube and reacted for 20 minutes at 37° C., the cDNA medical treatments labeled with Cy3- or Cy5- (50 μl, respectively) are mixed in one tube and is purified into a PCR purifying kit (QiaQuick PCR purification kit, Qiagen #28106) to prepare a mixed cDNA target of 80 μl finally. After the cDNA is deactivated for three minutes at 98° C., a control target of 25 μl with 2× hybridization buffer of 105 μl (Agilent In situ Hybridization kit) to be instilled on a mouse DNA microarray chip (TwinChip Mouse 7.4K cDNA array, Digital Genomics, Seoul, Korea) and hybridized for 17 hours at 60° C. Next, it is cleaned with a SSC/SDS mixed liquid and centrifuged for five minutes at 650 rpm and dried and then the fluorescence intensity of each gene is measured by Affymetrix 418 array scanner. Each fluorescence intensity is obtained by performing a global normalization and measuring the ratio of expressing Cy3- and Cy5- fluorescence with respect to one gene. The result is shown in the table 1 by classifying the expression ratio with respect to the mouse chip in use from mRNA of crypt cells of HFA/GF, HFA-TC/HFA, HFA-Cip/HFA in accordance with the genes and the functions of genes.

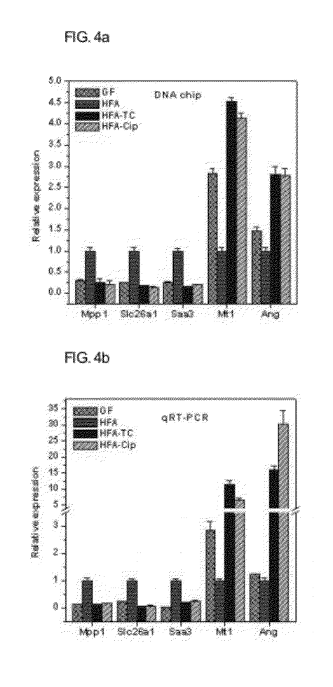

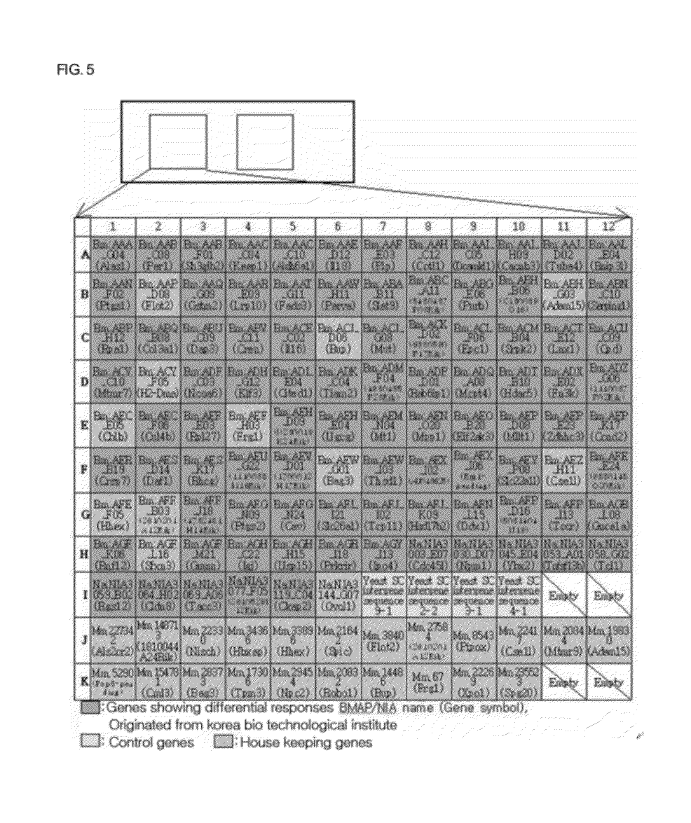

In comparison with the differences in the expressed genes between GF mice and HFA mice and the differences in the expressed genes between HFA mice and antibiotics (TC and Cip)-treated HFA mice, genes which are induced or decreased more than twice by the change of a human intestinal normal bacterial flora (FIGS. 3A and 4A). As shown in FIG. 3A, Tegt and Spn2a prevent genes from expressing themselves more than twice in comparison with HFA in HFA-TC and HFA-Cip, and Casp14, I16 and Eif2ak3 increase the expression of the genes in comparison with HFA in GF, HFA-TC and HFA-Cip. Furthermore, as shown in FIG. 4a, Mpp1, S1c26a1 and Saa3 prevent genes from expressing themselves more than twice in comparison with HFA in GF, HFA-TC and HFA-Cip, and Mt1 and Ang increase the expression of the genes in comparison with HFA in GF, HFA-TC and HFA-Cip nearly two or four times.

The Reactivity of the selected genes designed the primer of each gene using Beacon Designer 3.0 program (Table 1) and reconfirmed it by qRT-PCR method. (FIGS. 3b and 4b)

TABLE 1
Primer Design with Beacon Designer 3.0 program

| Gene | Primer | Gene Bank, |
|---|---|---|
| Symbol | sense/anti-sense | accession No |
| Tegt | SEQ ID NO: 1: TGGTTCGGTTCTCACAGTTC | AI844160 |
| | SEQ ID NO: 2: CAGTTAGGCAGCAGAGGAAG | |
| Dap3 | SEQ ID NO: 3: CTAACCCGAGTGAGGAATGC | AI464536 |
| | SEQ ID NO: 4: TCCATCCACAGCCACCAG | |
| Casp14 | SEQ ID NO: 5: GGACTTGAGCAGCCCTTC | AI448765 |
| | SEQ ID NO: 6: AGAGATGTCAGGACCACTAAC | |
| Rpa1 | SEQ ID NO: 7: AGAAGATGCTGACAAGTTTGAC | AI843650 |
| | SEQ ID NO: 8: TGGATGAGAGGACCGAGAG | |
| Ccnd2 | SEQ ID NO: 9: GAGGAATCAGAAACGAGAAGG | AI462808 |
| | SEQ ID NO: 10: AAGAGTATGCGACGGAGAG | |
| Cdc451 | SEQ ID NO: 11: CGGCAACAAGGAACCAATCAG | AA537036 |
| | SEQ ID NO: 12: CAGCGGCGGATACCTAGAAC | |
| Gmnn | SEQ ID NO: 13: GTCGTTCTGGCGTCGTTG | AI504205 |
| | SEQ ID NO: 14: CCTCCTGCTTCTGCTTCATAC | |
| Bnip3I | SEQ ID NO: 15: CACAACAACAACAACAACTG | AI480865 |
| | SEQ ID NO: 16: TTCCATTCTCATTGCCATTG | |
| Slc26a1 | SEQ ID NO: 17: GGTGGCTGGCAACATTCC | AI120514 |
| | SEQ ID NO: 18: AGGAGATGGAGAAGGCTGAG | |
| Ddx1 | SEQ ID NO: 19: GGATGTCCTGGCACCTACC | AI648064 |
| | SEQ ID NO: 20: ACTCCAATGCTCCTCTGTCTAC | |
| Sprr2a | SEQ ID NO: 21: TTGAGCCTTGTCTTCCTTC | AI414574 |
| | SEQ ID NO: 22: GTTGGGTGGTCACTTCTe | |
| Tuba4 | SEQ ID NO: 23: CTGTGTTGGATGATTGGACTAC | AI325223 |
| | SEQ ID NO: 24: TTGTGAGGTGGCTGTATGC | |
| Ang | SEQ ID NO: 25: GTGCTGGGTCTGGTTGTG | |
| | SEQ ID NO: 26: GGCTTCTTCTCTTCATCATACG | |
| Igj | SEQ ID NO: 27: AGACGATGGTGTTCCTGAGAC | AI323815 |
| | SEQ ID NO: 28: TGGCTCAAGCTAGTCAAGGTAG | |
| Saa3 | SEQ ID NO: 29: AGAGGCTGTTCAGAAGTTCAC | PA881525 |
| | SEQ ID NO: 30: GCAGGTCGGAAGTGGTTG | |
| De | SEQ ID NO: 31: TGCTGTCGCTGTCTCTGTTG | AI265267 |
| | SEQ ID NO: 32: TATGCCACTTGCTTTGCTCAG | |
| Tnfsf13b | SEQ ID NO: 33: AAGGCTGCTGGCTGCTAC | AI467294 |
| | SEQ ID NO: 34: CGGCTGGTGTTGCTGAAC | |
| Il6 | SEQ ID NO: 35: AACCGCTATGAAGTTCCTCTC | NM-031168 |
| | SEQ ID NO: 36: TCCTCTGTGAAGTCTCCTCTC | |
| Prkrir | SEQ ID NO: 37: ACGAGCAGCCTTCTGTGTAG | AI595353 |
| | SEQ ID NO: 38: CAGCAGCAATCAAGTGAGGAG | |
| Serping1 | SEQ ID NO: 39: GCTCTACCACGCCTTCTCAG | AI843252 |
| | SEQ ID NO: 40: AGTTGCTCTTGGTGCTGTCTC | |
| Eif2ak3 | SEQ ID NO: 41: GACAGACTGCGGAGACAAC | AI427929 |
| | SEQ ID NO: 42: GTCCACGGTGCCATCTTC | |
| Mpp1 | SEQ ID NO: 43: CCTCCTCCGCCGCCTTAG | AW320029 |
| | SEQ ID NO: 44: CAGAGACAACCAGACGCAGTAG | |
| Lnx1 | SEQ ID NO: 45: ACATCATTCTCAAGGTCAAC | AI481287 |
| | SEQ ID NO: 46: TCTGCTACGGAACTTCTG | |
| Rgs12 | SEQ ID NO: 47: AACAGCCTGAGCAGCAATG | AI450971 |
| | SEQ ID NO: 48: AGAAGTAGCGAACACCAACAG | |
| Dcamkl1 | SEQ ID NO: 49: GTCTCTCCCTGTCTCCATAC | AI842333 |
| | SEQ ID NO: 50: CCAACTCACCAAGCACAAG | |
| MlIt1 | SEQ ID NO: 51: AAGATGCTGAAGAAGGCTACC | AI327428 |
| | SEQ ID NO: 52: GGTGTTGGTGACATTGAAGTG | |
| Peri | SEQ ID NO: 53: CAGCCACGGTTCTCAGAG | AI836113 |
| | SEQ ID NO: 54: CACACGCCATCACATCAAG | |
| Hdac5 | SEQ ID NO: 55: TGGAGATGTGGAATACCTGAC | AI426555 |
| | SEQ ID NO: 56: TGGCGGTGACAGAATAGC | |
| Ncoa6 | SEQ ID NO: 57: AGCAGCCACAACCACAAC | AA517662 |
| | SEQ ID NO: 58: GGAGACTGGAAGCCTAATGG | |
| H2-DMa | SEQ ID NO: 59: GGAGCAGAGGAAGAAGACAATG | AI844653 |
| | SEQ ID NO: 60: CACACGAGATTGACCGCTAC | |
| Hhex | SEQ ID NO: 61: TACACGCACGCCCTACTC | AI450826 |
| | SEQ ID NO: 62: CTCACTTGACCGCCTTTCC | |

By the above method, 90 specific genes and 26 house-keeping genes were selected and the Bones of four control genes were guaranteed. (Refer to table 2 and FIG. 5)

90 specific genes include: Dap3, Rpa1, Ccnd2, Cdc45I, Gmnn, Cul4b, Tacc2, Bnip3I, Slc26a1, Ddx1, Cacnb3, Rpl27, Slc22a1I, Cav, Tuba4, Lrp10, Mt-1, Tiam2, Zdhhc3, Rhcg, Ipo4, 2610529I12Rik, Igj, Daf1, II18, Tnfsf13b, Prkrir, Serping1, Eif2ak3, Mpp1, Lnx1, 4732481h14Rik, Rgs12, Dcamkl1, Mllt1, Per1, Keap1, Hdac5, Ncoa6, Crem, Crsp7, Rnf12, Alas1, Cotl11, Gstm2, Siat9, 5430437P03Rik, Purb, Col3a1, II16, Mut, 6330590F17Rik, Srpk2, Klf3, Cited1, D230019K24Rik, Ugcg, Au043625, Rw1-pending, Hsd17b2, 5031404N19, Tccr, Npm1, Sh3glb2, Aldh6a1, Plp, Ptgs1, Fads3, Parva, C130039O16, Epc1, CPd, Mtmr7, 4930455F23Rik, Rab6ip1, Mcpt4, Fn3k, 1110037F02Rik, 1110038M16Rik, 1700012H17Rik, Thsd1, 9830148O20Rik, Ptgs2, Tcp11, Guca1a, Usp15, Ybx2, Tdl1, Cldn8, Ckap2.

26 house-keeping genes include: Flot2, Adam15, Bup, H2-Dma, Cblb, Frg1, Bag3, Cse1I, Hhex, 2610201A12Rik, Sfxn3, Ovol1, Als2cr2, Nisch, Hbxap, Spic, Pipox, Npc2, Robo1, Xpo1, Spg20, 1810044A24Rik, Mtmr9, Pop3-pending, Cml3, Tpm3.

4 control genes include: Yeast SC intergene sequence 9-1, Yeast SC intergene sequence 2-2, Yeast SC intergene sequence 3-1, Yeast SC intergene sequence 4-1.

The specific genes and control genes were distributed from Korea Biotechnological Institute and the clones were distributed as well at the same time and clone Ids (BMAP/NIA name) including the genes corresponding to each gene name were indicated in table 2. Furthermore, the control genes exist in yeast but not in mouse cells. Accordingly, the complementary genes of the present control genes were diluted at random and mixed with sample genes and then reacted with a gene chip. It is confirmed that results of testing the gene chip are reliable by the manifested control genes in accordance with the dilution multiples.

TABLE 2

| | | | Flod induction(Global M 2 [symbol] ) | | | |
|---|---|---|---|---|---|---|
| | Gene | | HFA/ | HFA-TC/ | HFA-Cip/ | |
| Group | symbol | BMAP/NIA name | GF | HFA | HFA | Gene function |
| Apoptosis | Tegt | — | 1.30 | −2.17 | −2.45 | Testis enhanced gene transcript |
| | Tnfrsf11b | — | 0.91 | −1.63 | −1.16 | TNF receptor superfamily |
| | Dap3 | Bm: ABU_C09 | −0.93 | 1.55 | 1.32 | Death associated protein 3 |
| | Casp14 | — | −1.23 | 1.69 | 1.40 | Casapse 14 |
| Cell | Rpa1 | Bm: ABP_H12 | 1.28 | −0.97 | −0.58 | Replication protein A1 |
| cycling | Ccnd2 | Bm: AEP_K17 | 1.13 | −1.82 | −1.19 | Cyclin D2 |
| | Calm2 | — | 0.90 | −1.85 | −1.46 | Calmodulin 2 |
| | Cdc45l | Na: NIA3003_E07 | −1.39 | 1.56 | 1.42 | Cell division cycle 45 homolog-like |
| | Gmnn | Bm: AGF_M21 | −1.53 | 1.43 | 1.31 | Geminin |
| | Cul4b | Bm: AEC_F06 | −1.32 | 2.02 | 1.52 | Cullin 4 B |
| | Tacc2 | Na: NIA3069_A06 | −1.30 | 1.87 | 1.53 | Transforming, acidic coiled-coil containing protein 3 |
| Cell | Trp63 | — | 1.18 | −1.11 | −1.03 | Transformation related protein 63 |
| death | Bnip3l | Bm: AAL_E04 | 1.02 | −1.54 | −1.57 | BCL2/adenovirus E1B 19 kDa-interacting protein |
| | | | | | | 3-like |
| Cell | Slc26a1 | Bm: AFI_I21 | 2.00 | −2.46 | −2.69 | Solute carrier family 26(sulfate transporter) |
| growth & | Ddx1 | Bm: AFN_L15 | 1.54 | −2.64 | −2.17 | (Asp-Glu-Ala-Asp) dox polypeptide1 |
| maintenance | Sprr2a | — | 1.47 | −3.37 | −2.36 | Small proline-rich protein 2A |
| | Cacnb3 | Bm: AAI_H09 | 2.43 | −1.40 | −1.33 | Ca channel, voltage-dependent beta 3 subunit |
| | Rpl27 | Bm: AEF_E03 | 1.08 | −2.24 | −1.29 | Ribosomal protein L27 |
| | Slc22a1l | Bm: AAJ_D02 | 1.14 | −2.24 | −2.12 | Solute carrier family 22 (organic cation |
| | | | | | | transporter), member 1-like |
| | Cav | Bm: AFG_N24 | 1.58 | −2.14 | −1.53 | Caveolin, caveolae protein |
| | Tuba4 | Bm: AEY_P08 | −1.59 | 1.92 | 1.64 | Tubulin alpha 4 |
| | Lrp10 | Bm: AAR_E09 | −1.03 | 2.37 | 1.62 | Low-density lipoprotein receptor-related protein 10 |
| | Krt1-10 | — | −1.60 | 2.14 | 1.64 | Keratin complex 1, acidic, gene 10 |
| | Slc13a1 | — | −2.30 | 1.62 | 1.43 | Solute carrier family13(Na/sulfate transporter) |
| | Ang | — | −0.55 | 1.49 | 1.48 | Angiogenin |
| | Mt-1 | Bm: AEM_N04 | −1.65 | 2.18 | 2.05 | Metallothionein 1 |
| | Tiam2 | BM: ADK_C04 | −1.43 | 1.81 | 1.54 | T-cell lymphoma invasion and metastasis 2 |
| | Zdhhc3 | Bm: AEP_E23 | −1.33 | 1.94 | 1.70 | Zinc finger, DHHC domain containing 3 |
| | Rhcg | Bm: AES_K17 | −1.49 | 1.74 | 1.53 | Rhesus blood group-associated C glycoprotein |
| | Ipo4 | Bm: AGY_I13 | −1.43 | 1.65 | 1.52 | Importin 4 |
| | 2610529I12Rik | Na: NIA3077_F05 | −1.20 | 2.19 | 1.61 | RIKEN cDNA 2610529I12 gene |
| Immune | Igj | Bm: AGH_C22 | 2.36 | −2.96 | −4.40 | Immunoglobulin joining chain |
| response | Saa3 | — | 1.95 | −2.62 | −2.23 | Serum amyloid A3 |
| | Daf1 | Bm: AES_D14 | 1.74 | −1.57 | −1.20 | Decay accelerating factor 1 |
| | Il18 | Bm: AAE_D12 | 1.27 | −1.51 | −1.42 | Interleukin 18 |
| | Tnfsf13b | Na: NIA3053_A01 | −1.44 | 1.49 | 1.29 | TNF (ligand) superfamily |
| | Cxcl7 | — | −1.79 | 1.67 | 1.59 | Chemokine (C—X—C motif) ligand 7 |
| | Il6 | — | −1.85 | 1.71 | 1.53 | Interleukin 6 |
| Response | Prkrir | Bm: AGR_I18 | 1.39 | −1.98 | −1.25 | PKA inf-inducible dsRNA dependent inhibitor |
| to stress | Serping1 | Bm: ABN_C10 | 1.88 | −1.75 | −0.93 | Serine proteinase inhibitor |
| | Tinf2 | — | 0.83 | −1.34 | −1.35 | TRF1-interacting nuclear factor 2 |
| | Gsta2 | — | 1.43 | −2.38 | −1.27 | Glutathione S-transferase, alpha 2 |
| | Avil | — | −1.06 | 1.36 | 1.38 | Advillin |
| | Eif2ak3 | Bm: AEO_B20 | −1.27 | 1.73 | 1.42 | Eukaryotic translation init. factor 2α kinase3 |
| Signal | Fgfr2 | — | 2.29 | −1.62 | −1.36 | Fibroblast growth factor receptor 2 |
| transduction | Pltx2 | — | 1.85 | −1.50 | −1.71 | Paired-like homeodomain transcription factor2 |
| | Mpp1 | Bm: AEN_O20 | 1.72 | −1.93 | −2.17 | Membrane protein, palmitoylated |
| | Lnx1 | Bm: ACT_E12 | 1.67 | −2.27 | −1.59 | Ligand of numb-protein X1 |
| | 4732481h14Rik | Bm: AFF_J18 | 1.76 | −1.99 | −1.56 | RIKEN cDNA 4732481H14 gene |
| | Rgs12 | Na: NIA3059_B02 | −1.33 | 1.87 | 1.47 | Regulator of G-protein signaling 12 |
| | Tbl3 | — | −1.48 | 1.24 | 1.19 | Transduction (beta)-like 3 |
| | Dcamkl1 | Bm: AAI_C05 | −1.53 | 1.62 | 1.08 | Double cortin & Ca/calmodulin-dependent protein |
| | | | | | | kinase-like1 |
| Transcription | Mllt1 | Bm: AEP_D08 | 1.73 | −1.53 | −1.81 | Myeloid/lymphoid or mixed lineage-leukemia |
| | | | | | | translocation to 1 homolog |
| | Per1 | Bm: AAB_C08 | 1.36 | −1.16 | −1.08 | Period homolog 1 |
| | Keap1 | Bm: AAC_C04 | 1.31 | −1.67 | −1.92 | Kelch-like ECH-associated protein 1 |
| | Hdac5 | Bm: ADT_B10 | −1.21 | 1.43 | 1.18 | Histone deacetylase 5 |
| | Ncoa6 | Bm: ADF_C03 | −1.74 | 1.67 | 1.54 | Nuclear receptor coactivator 6 |
| | Crem | Bm: ABV_C11 | −1.12 | 2.12 | 1.68 | cAMP responsive element modulator |
| | Crsp7 | Bm: AER_B19 | −1.13 | 2.53 | 1.56 | Cofactor required for Sp1 transcriptional |
| | | | | | | activation subunit 7, 70 kDa |
| | Rnf12 | Bm: AGF_K06 | −1.53 | 1.57 | 1.40 | Ring finger protein 12 |
| Others | Alas1 | Bm: AAA_G04 | 1.46 | −1.69 | −1.26 | Aminolevulinic avid synthase 1 |
| | Cotl11 | Bm: AAH_C12 | 2.23 | −1.38 | −1.26 | Coactosin-like 1 (Dictyostelium) |
| | Gstm2 | Bm: AAQ_G09 | 1.31 | −2.04 | −1.73 | Glutathione S-transferase, mu 2 |
| | Siat9 | Bm: ABA_B11 | 1.87 | −2.12 | −2.29 | Sialyltransferase 9 |
| | 5430437F03RiK | Bm: ABC_A11 | 1.40 | −1.71 | −1.17 | RIKEN cDNA 5430437P03 gene |
| | Purb | Bm: ABG_E06 | 1.40 | −2.55 | −1.79 | Purine rich element binding protein B |
| | Col3a1 | Bm: ABQ_B08 | 1.36 | −1.72 | −1.03 | Procollagen, type III, alpha 1 |
| | Il16 | Bm: ACE_C02 | 1.45 | −1.37 | −1.92 | Interleukin 16 |
| | Mut | Bm: ACJ_G08 | 1.32 | −1.54 | −2.59 | Methylmalonyl-Coenzyme A mutase |
| | 6330590F17Rik | Bm: ACK_D02 | 1.23 | −1.74 | −1.34 | RIKEN cDNA 6330590F17 gene |
| | Srpk2 | Bm: ACM_B04 | 1.09 | −2.60 | −1.78 | Serine/arginine-rich protein specific kinase 2 |
| | Klf3 | Bm: ADH_G12 | 1.32 | −2.14 | −2.23 | Kruppel-like factor 3 (basic) |
| | Cited1 | Bm: ADI_E04 | 1.17 | −2.34 | −2.27 | Cbp/p300-interacting transactivator with |
| | | | | | | Glu/Asp-rich carboxy-terminal domain 1 |
| | D230019K24Rik | Bm: AEH_D09 | 1.31 | −2.01 | −2.07 | RIKEN cDNA D230019K24 gene |
| | Ugcg | Bm: AEH_E04 | 1.28 | −2.59 | −2.31 | UDP-glucose ceramide glucosyltransferase |
| | Au043625 | Bm: AEX_I02 | 1.65 | −1.92 | −1.30 | Expressed sequence AU043625 |
| | Rwl-pending | Bm: AEX_I06 | 1.17 | −2.39 | −1.41 | Rwl protein |
| | Hsd17b2 | Bm: AFJ_K09 | 1.29 | −2.21 | −2.07 | Hydroxysteroid (17-beta) dehydrogenase 2 |
| | 5031404N19 | Bm: AFP_D16 | 1.24 | −1.71 | −1.47 | Hypothetical protein 5031404N19 |
| | Tccr | Bm: AFP_I13 | 1.55 | −2.90 | −2.24 | T cell cytokine receptor |
| | Npm1 | Na: NIA3030_D07 | 1.11 | −2.23 | −1.71 | Nucleophosmin 1 |
| Others | Sh3glb2 | Bm: AAB_F01 | −1.53 | 1.65 | 1.60 | SH3-domain GRB2-like endophilin B2 |
| | Aldh6a1 | Bm: AAC_C10 | −1.58 | 1.67 | 1.32 | Aldehyde dehydrogenase family 6, subfamily A1 |
| | Plp | Bm: AAF_E03 | −1.18 | 2.37 | 1.87 | Proteolipid protein (myelin) |
| | Ptgs1 | Bm: AAN_F02 | −1.94 | 2.68 | 1.59 | Prostaglandin-endoperoxide synthase 1 |
| | Fads3 | Bm: AAT_G11 | −1.39 | 1.98 | 1.66 | Zinc finger, DHHC domain containing 3 |
| | Parva | Bm: AAW_H11 | −1.21 | 1.95 | 1.69 | Parvin, alpha |
| | C130039O16 | Bm: ABH_B06 | −1.39 | 1.66 | 1.49 | Hypothetical protein C130039O16 |
| | Epc1 | Bm: ACL_F06 | −1.27 | 2.02 | 1.85 | Enhancer of polycomb homolog 1 (Drosophila) |
| | CPd | Bm: ACU_C09 | −1.54 | 1.62 | 1.48 | Carboxypeptidase D |
| | Mtmr7 | Bm: ACV_C10 | −1.32 | 1.80 | 1.61 | Myotubularin related protein 7 |
| | 4930455F23Rik | Bm: ADM_F04 | −1.42 | 1.61 | 1.39 | RIKEN cDNA 4930455F23 gene |
| | Rab6ip1 | Bm: ADP_D01 | −0.98 | 2.09 | 1.52 | Rab6 interacting protein 1 |
| | Mcpt4 | Bm: ADQ_A08 | −1.41 | 1.69 | 1.50 | Mast cell protease 4 |
| | Fn3k | Bm: ADX_E02 | −1.33 | 1.81 | 1.68 | Fructosamine 3 kinase |
| | 1110037F02Rik | Bm: ADZ_G06 | −1.49 | 1.52 | 1.49 | RIKEN cDNA 1110037F02 gene |
| | 1110038M16Rik | Bm: AEU_G22 | −1.47 | 1.87 | 1.47 | RIKEN cDNA 1110038M16 gene |
| | 1700012H17Rik | Bm: AEV_D01 | −1.51 | 3.10 | 1.97 | RIKEN cDNA 1700012H17 gene |
| | Thsd1 | Bm: AEW_I03 | −1.09 | 2.04 | 1.61 | Thrombospondin type I, domain 1 |
| | 9830148O20Rik | Bm: AFE_E24 | −1.43 | 1.65 | 1.45 | RIKEN cDNA 9830148O20 gene |
| | Ptgs2 | Bm: AFG_N09 | −1.87 | 1.67 | 1.54 | Prostaglandin-endoperoxide synthase 2 |
| | Tcp11 | Bm: AFJ_I02 | −1.30 | 1.99 | 1.66 | T-complex protein 11 |
| | Guca1a | Bm: AGB_L08 | −1.35 | 2.09 | 1.39 | Guanylate cyclase activator 1a (retina) |
| | Usp15 | Bm: AGH_H15 | −1.32 | 2.42 | 1.83 | Ubiquitin specific protease 15 |
| | Ybx2 | Na: NIA3045_E04 | −1.28 | 2.52 | 1.47 | Y box protein 2 |
| | Td1 | Na: NIA3058_G02 | −1.66 | 1.74 | 1.46 | T-cell lymphoma breakpoint 1 |
| | Cldn8 | Na: NIA3064_H02 | −1.28 | 1.88 | 1.63 | Claudin 8 |
| | Ckap2 | Na: NIA3119_C04 | −1.33 | 1.90 | 1.65 | Cytoskeleton associated protein 2 |
| House | Flot2 | Bm: AAP_D08 | 0.30 | −0.59 | −0.27 | Flotillin 2 |
| Keeping | Adam15 | Bm: ABH_G03 | −0.06 | −0.10 | 0.30 | A disintegrin and metalloproteinase domain 15 |
| | Bup | Bm: ACJ_D06 | 0.55 | −0.44 | −0.59 | Bmil upstream gene |
| | H2-Dma | Bm: ACY_F05 | 0.04 | −0.10 | −0.06 | Histocompatibility 2, class II, locus DMa |
| | Cblb | Bm: AEC_E05 | 0.11 | 0.47 | 0.40 | Casitas B-lineage lymphoma b |
| | Frg1 | Bm: AEF_H03 | 0.19 | 0.01 | −0.25 | FSHD region gene 1 |
| | Bag3 | Bm: AEW_G01 | 0.03 | 0.79 | 0.61 | Bcl2-associated athanogene 3 |
| | Cse1l | Bm: AEZ_H11 | −0.18 | 0.16 | 0.14 | Chromosome segregation 1-like (S. cerevisiae) |
| | Hhex | Bm: AFE_F05 | −0.06 | −0.15 | −0.23 | Hematopoietically expressed homeobox |
| | 2610201A12Rik | Bm: AFF_B03 | −0.28 | 0.78 | 0.67 | RIKEN cDNA 2610201A12 gene |
| | Sfxn3 | Bm: AGF_L16 | −0.08 | 0.26 | 0.21 | Sideroflexin 3 |
| | Ovol1 | Na: NIA3144_G07 | −0.46 | 0.56 | 0.46 | OVO homolog-like 1 (Drosophila) |
| | Als2cr2 | Mm.227342 | −0.50 | 0.61 | 0.35 | Amyotrophic lateral sclerosis 2 chromosome region |
| | Nisch | Mm.22330 | 0.65 | −0.20 | −0.44 | Nischarin |
| | Hbxap | Mm.34366 | 0.19 | 0.38 | 0.14 | Hypothetical protein Hbxap |
| | Spic | Mm.21642 | 0.52 | 0.87 | 1.31 | Spi-C transcription factor (Spi-1/PU.1 related) |
| | Pipox | Mm.8543 | −0.20 | 0.62 | 0.32 | Pipecolic acid oxidase |
| | Npc2 | Mm.29454 | 0.35 | −0.18 | −0.03 | Niemann Pick type C2 |
| | Robo1 | Mm.20832 | 0.13 | −0.93 | −0.69 | Roundabout homolog 1 (Drosophila) |
| | Xpo1 | Mm.22269 | 0.13 | −0.69 | −0.36 | Exportin 1, CRM1 homolog (yeast) |
| | Spg20 | Mm.235523 | −0.26 | 0.99 | 0.83 | Spestic paradegia 20, spartin (Troyer syndrome) |
| | | | | | | homolog (human) |
| | 1810044A24Rik | Mm.148713 | 0.33 | −0.23 | −0.10 | RIKEN cDNA 1810044A24 gene |
| | Mtmr9 | Mm.20844 | 0.42 | −0.25 | −0.03 | Myotubularin related protein 9 |
| | Pop3-pending | Mm.5290 | 0.21 | −0.65 | −0.14 | Popeye 3 |
| | Cml3 | Mm.154781 | −0.03 | 0.21 | 0.17 | Camello-like 3 |
| | Tpm3 | Mm.17306 | 0.10 | 0.14 | 0.65 | Tropomyosin 3, gamma |

[symbol]

indicates data missing or illegible when filed

### Embodiment 3

### Manufacturing a DNA Chip Showing Specific Responses to a Human Intestinal Normal Bacterial Flora

The 90 specific genes, 26 housekeeping genes and the clones of four control genes selected from the embodiment 2 were amplified by a PCR method using T7/T3. After the purity of the amplified genes was confirmed, genes were arrayed by 200 ng/μl per one gene on a glass slide (GAPS II, Amine coated, Corning) using a Microarrayer (Cartesian) to manufacture a DNA chip showing specific responses to a human intestinal bacterial flora.

In order to manufacture a gene chip, two sets of genes, one set comprising 120 genes, were arrayed on a glass slide. (FIG. 5) As the DNA chip test is sensitive, several repeated tests were required in order to obtain reliable test results. However, specimens are mostly limited and it is difficult to to perform the test repeatedly. In the present chip, two sets comprising the same genes are arrayed on one slide to improve the reliability of the test results by obtaining the results twice using the specimen with the same amount.

Syto 61 Dye of DNA Chip:

After cNDA is arrayed on a slide, Syto 61 (5 mM solution in DMSO) is instilled on a slide in order to confirm the uniformity of spots by the dying degree and the size of the spots to be reacted for five minutes at a room temperature. It was sufficiently cleaned with DW and the slide is dried by the centrifugation. The spot figure is analyzed at the 560 nm wavelength using DNA scanner. (FIG. 6) As seen from the spot figure, it is confirmed that the spots have the uniformity in size and intensify that the ratio where the standard deviation of an average diameter of all the spots divided by the average value is 0.16 or less and the ratio where the standard deviation of an intensity in a pixel is divided by the average value is 0.6 or less.

### Embodiment 4

### Effects of Colistin Using DNA Chip on Human Intestinal Normal Bacterial Flora

The colistin sulfate is dissolved in a drinking water (corresponding to 62.5 mg/kg of the weight of a mouse) by 500 μg/Ml and is daily administered to the HFA mice for three weeks and then the administration is halted for one week. The colon is collected and the gene expression of crypt cells obtained from the colon is compared with the control group (HFA mice). As a result, 33 genes including Lrp10 and the like of 90 specific genes are increased in comparison with more than 1.5 times by collistin sulfate and five genes including Cacnb3 is decreased more than 1.5 times in comparison with HFA. 25 genes including Lrp10 and Cacnb3 out of the 90 genes even have the same tendency of the increase and the decrease of genes observed when a human intestinal bacterial flora is disturbed (Table 3). It is assumed that the degree of the increase and the decrease of the genes in the present test is smaller in comparison with tetracycline or ciprofloxacin because of the recovery period of one week, but the change of genes is still detected because the administration of colistin sulfate by 500 μg/Ml has effects on the human intestinal bacterial flora. It is found that there are still abnormalities in the functions of the human intestinal bacterial flora even after the stop of administration for one week, and the crypt cells of the colon response to them and the expression of genes are different from the non-treated animals (HFA mice).

TABLE 3

| | | | Gene expression | | | |
|---|---|---|---|---|---|---|
| | Gene | | | HFA- | HFA-Coli/ | |
| Group | symbol | BMAP/NIA name | HFA | Coli | HFA | Gene function |
| Apoptosis | Dap3 | Bm: ABU_C09 | 498.0 | 634.5 | 1.274 | Death associated protein 3 |
| Cell | Rpa1 | Bm: ABP_H12 | 217.5 | 353.8 | 1.626 | Replication protein A1 |
| cycling | Ccnd2 | Bm: AEP_K17 | 376.0 | 315.5 | 0.839 | Cyclin D2 |
| | Cdc45l | Na: NIA3003_E07 | 61.00 | 100.8 | 1.652 | Cell division cycle 45 homolog-like |
| | Gmnn | Bm: AGF_M21 | 676.0 | 673.8 | 0.997 | Geminin |
| | Cul4b | Bm: AEC_F06 | 53.50 | 91.75 | 1.715 | Cullin 4B |
| | Tacc2 | Na: NIA3069_A06 | 78.75 | 179.5 | 2.279 | Transforming, acidic coiled-coil containing |
| | | | | | | protein 3 |
| Cell | Bnip3l | Bm: AAL_E04 | 416.2 | 729.5 | 1.753 | BCL2/adenovirus E1B 19 kDa-interacting |
| death | | | | | | protein 3-like |
| Cell | Slc26a1 | Bm: AFI_I21 | 156.2 | 203.5 | 1.302 | Solute carrier family 26(sulfate transporter) |
| growth & | Ddx1 | Bm: AFN_L15 | 338.2 | 370.0 | 1.094 | (Asp-Glu-Ala-Asp) dox polypeptide1 |
| maintenance | Cacnb3 | Bm: AAI_H09 | 1019 | 661.2 | 0.649 | Ca channel, voltage-dependent, beta 3 subunit |
| | Rpl27 | Bm: AEF_E03 | 1732 | 1768 | 1.021 | Ribosomal protein L27 |
| | Slc22a1l | Bm: AAJ_D02 | 1586 | 1671 | 1.054 | Solute carrier family 22 (organic |
| | | | | | | cation transporter), member 1-like |
| | Cav | Bm: AFG_N24 | 200.2 | 206.0 | 1.029 | Caveolin, caveolae protein |
| | Tuba4 | Bm: AEY_P08 | 559.0 | 799.2 | 1.623 | Tubulin alpha 4 |
| | Lrp10 | Bm: AAR_E09 | 773.2 | 1648 | 2.132 | Low-density lipoprotein receptor-related protein 10 |
| | Mt-1 | Bm: AEM_N04 | 563.2 | 2033 | 3.610 | Metallothionein 1 |
| | Tiam2 | Bm: ADK_C04 | 21.25 | 160.8 | 7.565 | T-cell lymphoma invasion and metastasis 2 |
| | Zdhhc3 | Bm: AEP_E23 | 209.2 | 357.8 | 1.710 | Zinc finger, DHHC domain containing 3 |
| | Rhcg | Bm: AES_K17 | 182.2 | 286.5 | 1.572 | Rhesus blood group-associated C glycoprotein |
| | Ipo4 | Bm: AGY_I13 | 54.75 | 140.5 | 2.566 | Importin 4 |
| | 2610529I12Rik | Na: NIA3077_F05 | 1056 | 1108 | 1.049 | RIKEN cDNA 2610529I12 gene |
| Immune | Igj | Bm: AGH_C22 | 237.0 | 210.5 | 0.888 | Immunoglobulin joining chain |
| response | Daf1 | Bm: AES_D14 | 201.0 | 419.0 | 2.085 | Decay accelerating factor 1 |
| | Il18 | Bm: AAE_D12 | 486.0 | 531.5 | 1.094 | Interleukin 18 |
| | Tnfsf13b | Na: NIA3053_A01 | 119.2 | 256.8 | 2.153 | TNF (ligand) superfamily |
| Response | Prkrir | Bm: AGR_I18 | 792.0 | 510.0 | 0.644 | PKA, inf-inducible dsRNA dependent inhibitor |
| to stress | Serping1 | Bm: ABN_C10 | 137.5 | 153.0 | 1.113 | Serine proteinase inhibitor |
| | Eif2ak3 | Bm: AEO_B20 | 537.5 | 685.0 | 1.274 | Eukaryotic translation init factor 2α kinase3 |
| Signal | Mpp1 | Bm: AEN_O20 | 730.2 | 638.0 | 0.874 | Membrane protein, palmitoylated |
| transduction | Lnx1 | Bm: ACT_E12 | 575.8 | 98.25 | 0.171 | Ligand of numb-protein X1 |
| | 4732481h14Rik | Bm: AFF_J18 | 279.0 | 209.2 | 0.750 | RIKEN cDNA 4732481H14 gene |
| | Rgs12 | Na: NIA3059_B02 | 109.5 | 152.8 | 1.395 | Regulator of G-protein signaling 12 |
| | Dcamkl1 | Bm: AAI_C05 | 905.5 | 615.2 | 0.679 | Double cortin & Ca/calmodulin-dependent |
| | | | | | | protein kinase-like1 |
| Transcription | Mllt1 | Bm: AEP_D08 | 643.5 | 502.8 | 0.781 | Myeloid/lymphoid or mixed lineage- |
| | | | | | | leukemia translocation to 1 homolog |
| | Per1 | Bm: AAB_C08 | 655.0 | 803.5 | 1.227 | Period homolog 1 |
| | Keap1 | Bm: AAC_C04 | 821.5 | 564.0 | 0.687 | Kelch-like ECH-associated protein 1 |
| | Hdac5 | Bm: ADT_B10 | 499.2 | 473.8 | 0.949 | Histone deacetylase 5 |
| | Ncoa6 | Bm: ADF_C03 | 122.0 | 374.5 | 3.070 | Nuclear receptor coactivator 6 |
| | Crem | Bm: ABV_C11 | 399.8 | 355.8 | 0.890 | cAMP responsive element modulator |
| | Crsp7 | Bm: AER_B19 | 595.8 | 1218 | 2.045 | Cofactor required for Sp1 transcriptional |
| | | | | | | activation, subunit 7, 70 kDa |
| | Rnf12 | Bm: AGF_K06 | 58.75 | 72.50 | 1.234 | Ring finger protein 12 |
| Others | Alas1 | Bm: AAA_G04 | 310.8 | 577.0 | 1.857 | Aminolevulinic avid synthase 1 |
| | Cotl11 | Bm: AAH_C12 | 669.5 | 1227 | 1.883 | Coactosin-like 1 (Dictyostelium) |
| | Gstm2 | Bm: AAQ_G09 | 174.5 | 164.8 | 0.944 | Glutathione S-transferase, mu 2 |
| | Siat9 | Bm: ABA_B11 | 1425 | 1439 | 1.010 | Sialyltransferase 9 |
| | 5430437F03Rik | Bm: ABC_A11 | 266.0 | 485.8 | 1.826 | RIKEN cDNA 5430437P03 gene |
| | Purb | Bm: ABG_E06 | 216.5 | 527.8 | 2.438 | Purine rich element binding protein B |
| | Col3a1 | Bm: ABQ_B08 | 206.5 | 441.0 | 2.136 | Procollagen, type III, alpha 1 |
| | Il16 | Bm: ACE_C02 | 386.5 | 568.0 | 1.470 | Interleukin 16 |
| | Mut | Bm: ACJ_G08 | 807.5 | 999.5 | 1.238 | Methylmalonyl-Coenzyme A mutase |
| | 6330590F17Rik | Bm: ACK_D02 | 63.00 | 84.50 | 1.341 | RIKEN cDNA 6330590F17 gene |
| | Srpk2 | Bm: ACM_B04 | 651.0 | 312.2 | 0.480 | Serine/arginine-rich protein specific kinase 2 |
| | Klf3 | Bm: ADH_G12 | 256.2 | 195.8 | 0.764 | Kruppel-like factor 3 (basic) |
| | Cited1 | Bm: ADI_E04 | 236.5 | 289.0 | 1.222 | Cbp/p300-interacting transactivator with |
| | | | | | | Glu/Asp-rich carboxy-terminal domain 1 |
| | D230019K24Rik | Bm: AEH_D09 | 54.75 | 142.2 | 2.598 | RIKEN cDNA D230019K24 gene |
| | Ugcg | Bm: AEH_E04 | 1855 | 1158 | 0.625 | UDP-glucose ceramide glucosyltransferase |
| | Au043625 | Bm: AEX_I02 | 288.2 | 336.5 | 1.167 | Expressed sequence AU043625 |
| | Rwl-pending | Bm: AEX_I06 | 302.2 | 490.5 | 1.623 | Rwl protein |
| | Hsd17b2 | Bm: AFJ_K09 | 1196 | 1737 | 1.453 | Hydroxysteroid (17-beta) dehydrogenase 2 |
| | 5031404N19 | Bm: AFP_D16 | 464.5 | 444.2 | 0.956 | Hypothetical protein 5031404N19 |
| | Tccr | Bm: AFP_I13 | 830.8 | 682.0 | 0.821 | T cell cytokine receptor |
| | Npm1 | Na: NIA3030_D07 | 190.2 | 350.0 | 1.840 | Nucleophosmin 1 |
| | Sh3glb2 | Bm: AAB_F01 | 534.8 | 578.0 | 1.081 | SH3-domain GRB2-like endophilin B2 |
| | Aldh6a1 | Bm: AAC_C10 | 295.0 | 286.5 | 0.971 | Aldehyde dehydrogenase family 6, subfamily A1 |
| | Plp | Bm: AAF_E03 | 1712 | 2108 | 1.232 | Proteolipid protein (myelin) |
| | Ptgs1 | Bm: AAN_F02 | 1076 | 2454 | 2.280 | Prostaglandin-endoperoxide synthase 1 |
| | Fads3 | Bm: AAT_G11 | 287.8 | 409.2 | 1.422 | Zinc finger, DHHC domain containing 3 |
| | Parva | Bm: AAW_H11 | 115.0 | 153.0 | 1.330 | Parvin alpha |
| | C130039O16 | Bm: ABH_B06 | 586.2 | 680.0 | 1.160 | Hypothetical protein C130039O16 |
| | Epc1 | Bm: ACL_F06 | 157.5 | 228.8 | 1.452 | Enhancer of polycomb homolog 1 |
| | CPd | Bm: ACU_C09 | 692.8 | 587.8 | 0.848 | Carboxypeptidase D |
| | Mtmr7 | Bm: ACV_C10 | 83.00 | 173.0 | 2.084 | Myotubularin related protein 7 |
| | 4930455F23Rik | Bm: ADM_F04 | 745.2 | 634.5 | 0.851 | RIKEN cDNA 4930455F23 gene |
| | Rab6ip1 | Bm: ADP_D01 | 74.50 | 203.0 | 2.725 | Rab6 interacting protein 1 |
| | Mcpt4 | Bm: ADQ_A08 | 120.8 | 181.8 | 1.505 | Mast cell protease 4 |
| | Fn3k | Bm: ADX_E02 | 529.5 | 415.5 | 0.785 | Fructosamine 3 kinase |
| | 1110037F02Rik | Bm: ADZ_G06 | 10.00 | 133.2 | 13.33 | RIKEN cDNA 1110037F02 gene |
| | 1110038M16Rik | Bm: AEU_G22 | 144.5 | 195.8 | 1.355 | RIKEN cDNA 1110038M16 gene |
| | 1700012H17Rik | Bm: AEV_D01 | 612.8 | 594.0 | 0.969 | RIKEN cDNA 1700012H17 gene |
| | Thsd1 | Bm: AEW_I03 | 348.0 | 477.8 | 1.373 | Thrombospondin type I, domain 1 |
| | 9830148O20Rik | Bm: AFE_E24 | 582.2 | 815.0 | 1.400 | RIKEN cDNA 9830148O20 gene |
| | Ptgs2 | Bm: AFG_N09 | 246.2 | 423.8 | 1.721 | Prostaglandin-endoperoxide synthase 2 |
| | Tcp11 | Bm: AFJ_I02 | 439.0 | 536.5 | 1.222 | T-complex protein 11 |
| | Guca1a | Bm: AGB_L08 | 268.5 | 417.0 | 1.553 | Guanylate cyclase activator 1a (retina) |
| | Usp15 | Bm: AGH_H15 | 62.75 | 85.00 | 1.355 | Ubiquitin specific portease 15 |
| | Ybx2 | Na: NIA3045_E04 | 111.5 | 164.8 | 1.478 | Y box protein 2 |
| | Tcl1 | Na: NIA3058_G02 | 172.0 | 290.2 | 1.688 | T-cell lymphoma breakpoint 1 |
| | Cldn8 | Na: NIA3064_H02 | 340.2 | 406.5 | 1.195 | Claudin 8 |
| | Ckap2 | Na: NIA3119_C04 | 330.0 | 548.0 | 1.661 | Cytoskeleton associated protein 2 |

### Embodiment 5

### Change of Composition of Human Intestinal Normal Bacterial Flora During Medication of Colistin Sulfate

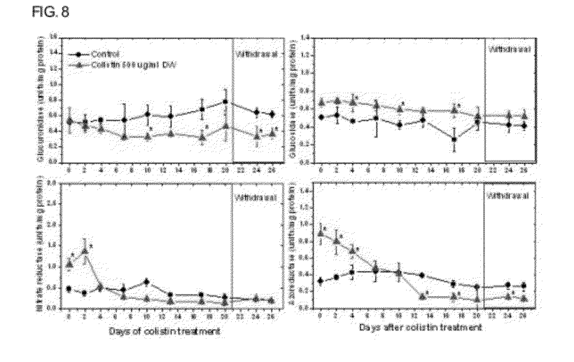

The colistin sulfate is dissolved in a drinking water (corresponding to 62.5 mg per kg of the weight of a mouse) by 500 μg/Ml and is daily administered to the HFA mice for three weeks and then the administration is halted for one week. For the one week, the feces were picked asceptially with the interval of two to three days. The feces collected of colistin sulfate administeration, 2^{nd}, 4^{th}, 7^{th}, 10^{th}, 13^{th} and 17^{th} days are put in an encapsulated tube and moved to an anaerobic chamber immediately and is put in the PRAS (Prereduced and anaerobically sterilized) TGY medium with the ten times dilution of the weight of feces. The total number of anaerobic bacteria, the number of Bacteroides fragilis and Bifidobacterium spp. of the anaerobic bacteria, the number of aerobic bacteria, and the number of Esherichia coli and Enterococcus spp. of the aerobic bacteria are measured. As a result, the total number of anaerobic bacteria is increased by about twice by colistin sulfate at the 17^{th} day in comparison with HFA mice and the number of aerobic bacteria is decreased at the 7^{th}, 10^{th}, and 13^{th} day from the medication. Especially, Esherichia coil is decreased about 100 to 1000 times from the date of medication through 17^{th} day and Enterococcus spp. is decreased in similar way to the control group at the 4^{th} and 27^{th} day from the medication. (FIG. 7)

### Embodiment 6

### Change of Functions of a Human Intestinal Normal Bacterial Flora by Administration of Colistin Sulfate

The colistin sulfate is dissolved in a drinking water (corresponding to 62.5 mg/kg of the weight of a mouse) by 500 μg/Ml and is daily administered to the HFA mice for three weeks and then the administration is hafted for one week. For the one week, the feces were picked free from germs with the interval of two to three days. The feces collected at the day of colistin sulfate administration, 2^{nd}, 4^{th}, 7^{th}, 10^{th}, 13^{th}, 17^{th} and 20^{th} days and at 3^{rd} and 5^{th} day after the stop of medication are put in an encapsulated tube and moved to an anaerobic chamber immediately and the activity of glucuomidase, glucosidase, nitrate reductase and azoreductase produced by the human intestinal normal bacterial flora is measured. As a result glucuronidase is decreased throughout the period of administration and the withdrawal period in comparison with control groups and is not recovered even at the 5^{th} day since the medication is stopped. Glucosidase is increased during the medication period in comparison with the control groups. Nitrate reductase is increased in comparison with the control group at the start day of administration and the 2^{nd} day of the medication but is recovered. Azoreductase is increased in comparison with the control group until the 7th day of medication and then decreased. The decrease of Azoreductase is not even recovered at the 5th day since the medication is stopped.

### Embodiment 8

### Estimation of Disturbing a Human Intestinal Normal Bacterial Flora of Colistin Sulfate Using DNA Chip Showing Specific Response to a Human Intestinal Normal Bacterial Flora

DNA chip showing specific response to a human intestinal normal bacterial flora:

In case that unknown chemical materials are orally intaken in order to estimate if they disrupt a human intestinal normal bacterial flora or in case that medical supplies used to stocks provided for eating in order to examine the effects on the human intestinal normal bacterial flora before they are allowed to consume, or in order to know if the materials which might disrupt the human intestinal normal bacterial flora is contaminated by foods, the gene chip according to the present invention can preferably be used as a simple and sensitive method. In other words, the material or the food is orally administered to HFA mice, which are autopsied along with control HFA mice not having been administered. The crypt cells of the colon are collected to separate RNA. Next, the separated RNA is amplified and Cy3 fluorescence material is labelled on the genes of HFA mice and Cy5 fluorescence material is labelled on the genes of the administered group to react with the gene chip which is a product of the present invention to get the difference of expressions of the 90 genes. When analyzing the degree of expressions of genes, it is confirmed that the control group expresses fluorescence in accordance with the dilution numbers, and that the housekeeping genes are well expressed in general and are normalized to the fluorescence degree of the entire genes. If above 10% or more than 10 genes out of all the specific genes show the increase or the decrease by 1.5 times or more by observing the change of 90 specific genes such as Sh3glb2 and Alas1 and the like which are known to increase or decrease the expression when a human intestinal normal bacterial flora is disturbed or changed, it is estimated that the test material is a material which causes the human intestinal normal bacterial flora to be changed.

The colistin sulfate is dissolved in a drinking water (corresponding to 62.5 mg/kg of the weight of a mouse) by 500 μg/Ml and is daily administered to the HFA mice for three weeks and then the administration is halted for one week. RNA is collected and amplified from the crypt cells of the colon to manufacture a DNA chip, which is reacted with RNA of HFA mice being the control group. The degree of expressing genes and the change of composition of intestinal normal bacterial flora of the colon and the activity of the enzymes produced by the human intestinal bacterial flora such as glucuomidase, glucosidase, nitrate reductase and azoreductase are investigated and used as an index showing the disruption of the human intestinal normal bacterial flora.

33 genes including Lrp10 of 90 specific genes are increased by more than 1.5 times in comparison with HFA and five genes induding Cacnb3 is decreased by more than 1.5 times in comparison with HFA out of the 90 specific genes by colistin sulfate in a DNA chip showing specific responses to the human intestinal normal bacterial flora. That is, 38 genes in total showed the difference by more than 1.5 times in comparison with the control group. 25 genes including Lrp10 and Cacnb3 have the same tendency as that of the increase and decrease of genes observed when a human intestinal normal bacterial flora is disrupted. It was found out that the administration of colistin sulfate causes the human intestinal normal bacterial flora to be disrupted, which is not recovered in one week after the administration of colistin is stopped.

Especially Escerichia coli of the human intestinal normal bacterial flora is decreased about 100 to 1000 times in comparison with the control group during the medication period and it is found out that colistin sulfate causes the human intestinal normal bacterial flora to be disrupted. In addition, the activities of glucosidase and azoreductase out of the enzymes produced by the human intestinal normal bacterial flora are not recovered at 5^{th} day since the medication is stopped, and it is found out that there still remain the abnormalities of the functions of the human intestinal normal bacterial flora even after the medication is stopped. Therefore, it is concluded that it has a dose relationship with that of the genes showing specific responses to a human intestinal normal bacterial flora.

As described above, the present invention uses a chip manufactured by selecting genes which sensitively react with the human intestinal normal bacterial flora and it is possible to estimate the harmness of an infinitesimal of antibacterial material remaining in the food to the human body promptly and sensitively. Furthermore, it is possible to estimate the abnormalities of living bodies caused by the change of human intestinal normal bacterial flora due to the exposure to the drugs, exterior pathogens and harmful chemical materials directly, simply and sensitively.

TABLE 4

| SEQ ID NO: | Gene Symbol | BMAP name |
|---|---|---|
| SEQ ID NO: 63 | Mt-1 | Bm: AEM_N04 |
| SEQ ID NO: 64 | PtgS1 | Bm: AAN_F02 |
| SEQ ID NO: 65 | Ncoa6 | Bm: ADF_C03 |
| SEQ ID NO: 66 | Tiam2 | Bm: ADK_C04 |
| SEQ ID NO: 67 | Mtmr7 | Bm: ACV_C10 |
| SEQ ID NO: 68 | Ipo4 | Bm: AGY_I13 |
| SEQ ID NO: 69 | Crsp7 | Bm: AER_B19 |
| SEQ ID NO: 70 | Lrp10 | Bm: AAR_E09 |
| SEQ ID NO: 71 | 1110037F02Rik | Bm: ADZ_G06 |
| SEQ ID NO: 72 | Rab6ip1 | Bm: ADP_D01 |

1-5. (canceled)

6. A method for estimating the harmness to a human body due to the change of a human intestinal normal bacterial flora, comprising:
(1) reacting cDNA labeling a fluorescent material from RNA sampled and amplified from a colonic crypt cells to a DNA chip comprising genes of SEQ ID NO: 63 to SEQ ID NO:
68 attached to a substrate; and
(2) confirming a fluorescent degree of the degree of gene expression on the DNA chip via a DNA scanner.

7. The method according to claim 6, wherein the DNA chip further comprises genes of SEQ ID NO: 69 to SEQ ID NO: 72.

8. The method according to claim 6, wherein the DNA chip shows specific responses of colonic crypt cells.

9. The method according to claim 6, wherein the specific responses of colonic crypt cells indicate a change of functions of a large intestine according to a human intestinal normal bacterial flora.
